(19) United States
(12) Patent Application Publication
(10) Pub. No.: US 2014/0337082 A1
(43) Pub. Date: Nov. 13, 2014

(54) ENERGY AUDIT TOOL

(71) Applicant: Jorj Nofal, Tempe, AZ (US)

(72) Inventor: Jorj Nofal, Tempe, AZ (US)

(21) Appl. No.: 14/246,030

(22) Filed: Apr. 4, 2014

Related U.S. Application Data
(60) Provisional application No. 61/808,551, filed on Apr. 4, 2013.

(51) Int. Cl. G06Q 10/06

(52) U.S. Cl. CPC G06Q 10/06315
USPC 705/7.25

(57) ABSTRACT

An energy audit tool is provided. The energy audit tool includes a server, a communication device in communication with the server, and an onsite and secure web-based application tool operable on the communication device. The onsite and secure web-based application tool comprises a plurality of modules for performing audit functions. The communication device includes a computing device, such as a mobile computing device. The plurality of modules may include a lighting module, an HVAC module, a Water Heating module, a PC Power Management module, an ES Refrigerators module, a VFD on Evap Fans module, a VFD on Kitchen Exhaust Fans module, a PLOS module, an Auto Door Closers module, an HE Cooking Equipment module, an HE Ice Maker module, and a Vending Misers module.

### CROSS REFERENCE TO RELATED APPLICATION[S]

This application claims priority to U.S. Provisional patent application entitled “Energy Audit Tool,” Ser. No. 61/808,551, filed Apr. 4, 2013, now pending, the disclosures of which are hereby incorporated entirely herein by reference.

### BACKGROUND OF THE INVENTION

1. Technical Field

This invention relates generally to an audit tool and more particularly to a web-based energy audit tool.

2. State of the Art

Businesses are often looking for opportunities to reduce the expenditures that have on a daily, weekly, monthly and/or yearly basis. Fluctuations in the economy often contribute to businesses seeking additional ways to cut back on their expenditures. One way in which a company does this is by determining their costs directed to the energy usage of their office space, building and the like. This requires an energy audit of the building in order to determine the efficiency at which energy consumption is occurring. These audits help to identify issues and inefficiencies with the current systems and possible options to reduce the costs.

Conventional energy audits are very time consuming because they require an extreme amount of manual processing. Further, quality control of the energy audit by utility representatives or by a peer reviewer within the auditor's firm often adds weeks to the time between testing and when the customer is presented with the audit report. There are also no software tools exists that do integrated energy and demand (“IDSM”) audits as well as water conservation audits within a single software. Typically customers or utilities have these audits performed separately by separate engineers or engineering firms resulting in additional delays and increased cost. Additionally, urgency for action is lost as the report is being finalized, thereby losing valuable decision and implementation time by the customer. The untimeliness of these audits delays action and related savings and can have additional negative effects, such as, but not limited to the customers inability to qualify for utility company incentives due to time restrictions for filing incentive requests. Similarly, incentives can be lost where the application for incentives needs to be filed prior to implementing savings procedures but the company, being anxious to begin savings, initiates procedures while waiting for the audit results, which audit results are necessary to apply for the incentives. Thus the company is caught between the options of delaying the implementation of savings procedures until the audit report is received or implement savings procedures immediately and lose the incentives. Also, since all reports are kept in hard copy, or in a report format, the data inventory or data mining is unavailable with the reports rarely being revisited.

### SUMMARY OF EMBODIMENTS

The present invention relates to an energy audit tool for quickly and accurately performing IDSM audits and developing reports regarding the same.

Embodiments of the energy audit tool include an on-site audit capability via a secure web-based application tool (with https and SSL) for performing IDSM audits. The tool utilizes uniform and standardized engineering methodology reducing elapsed time between audit, quality control, and report generation. The analyses and costs are based on generally accepted engineering principals, such as, but not limited to, ASHRAE Level I and II audit with interactive effects, eQuest energy modeling based building types and load curves, and energy savings and measure cost databases such as DEER database.

Embodiments include a paperless process from data gathering through calculations producing a standard, editable report with the ability to post photos into the report directly from a handheld device. The tool may be utilized with various platforms and operating systems, such as, but not limited to, Apple and Android based hardware.

The tool operates to generate a report for each IDSM measure within the module and compiles each into a fully editable report. The report is a standardized report template which will allow for reduced quality control time as well as reduced overall days to deliver the report.

The tool also allows for utility managers to perform numerous functions. For example, and not by way of limitation, the utility managers may analyze each customer's results which are saved under the customer's name and assigned auditor; maintain, evaluate, and collate buildings and search audit data, measure details, and customer facilities for several years following an energy audit of the facilities; manage the audit work for multiple field engineers as well as track the status of audits; and track performance and savings potential through data mining and analysis.

The foregoing and other features and advantages of the present invention will be apparent from the following more detailed description of the particular embodiments of the invention.

### BRIEF DESCRIPTION OF THE DRAWINGS

FIG. 1 is a view of a Contact Information Input Page;

FIG. 2 is a view of a Customer Info tab;

FIG. 3 is a view of a Utility Info Tab;

FIG. 4 is a view of Electric Audit Inputs;

FIG. 5 is a view of Gas Audit Inputs;

FIG. 6 is a view of Water Audit Inputs;

FIG. 7 is a view of 12 Months Billing History Inputs;

FIG. 8 is a view of Building Info Tab;

FIG. 9 is a view of Architecture Tab Inputs for Building Orientation, Floor Heights, Roof Surfaces, and Above Grade Walls;

FIG. 10 is a view of Architecture Tab Inputs for Ground Floor, Ceiling, and Floors;

FIG. 11 is a view of Architecture Tab Inputs for Exterior Doors;

FIG. 12 is a view of Architecture Tab Inputs for Exterior Windows and Roof Skylights;

FIG. 13 is a view of “Create New Customer” Link;

FIG. 14 is a view of “Add New Building” Link;

FIG. 15A is a view of Interior Existing Lighting Inputs;

FIG. 15B is a view of Interior Proposed Lighting Inputs;

FIG. 15C is a view of Exterior Existing Lighting Inputs;

FIG. 15D is a view of Exterior Proposed Lighting Inputs;

FIG. 15E is a view of Lamp Type Explanation;

FIG. 15F is a view of Interior Lighting Tab with Annual Savings;

FIG. 15G is a view of Exterior Lighting Tab with Annual Savings;

FIG. 15H is a view of Blank Results Tab;

FIG. 15I is a view of Results Tab with Results;

FIG. 15J is a view of Report Tab;

FIG. 15K is a view of Pictures Tab;

FIG. 16A is a view of HVAC Input Tab User Inputs: “Inventory Only?” Thru “Number of Holidays”;

FIG. 16B is a view of HVAC Input Tab User Inputs: “Propose Alternate Operating Schedule”;

FIG. 17A is a view of HVAC Inventory Tab: User Inputs “Unit Description” Thru “Economizer kWh Savings”;

FIG. 17B is a view of HVAC Inventory Tab: User Inputs“DCV kWh Savings” Thru “Total Measure Cost”;

FIG. 18 is a view of Press the “Edit” button next to the unit you want to edit;

FIG. 19 is a view of Make any changes to the Inputs that are needed;

FIG. 20 is a view of Press the “Save and Add” button;

FIG. 21 is a view of A Dialogue Box will appear which says “Data Added Successfully”;

FIG. 22 is a view of Press the “Save and Continue” button;

FIG. 23 is a view of You will be taken back to the HVAC Inventory tab;

FIG. 24 is a view of Press the “Remove” button;

FIG. 25 is a view of The Unit will be removed from the HVAC Inventory;

FIG. 26 is a view of Click on the Input tab or the Previous button to enter more HVAC Units;

FIG. 27 is a view of Click on the “Save and Continue” button to move onto the next tab;

FIG. 28 is a view of Click on the “Next” button for the tab you wish to edit;

FIG. 29 is a view of WSHP Boiler Retrofit Tab: User Inputs “Inventory Only” to “Unit Type”;

FIG. 30 is a view of WSHP Boiler Retrofit tab: User Inputs “Make/Model” to “Total Measure Cost”;

FIG. 31 is a view of Inventory and savings calculations of WSHP Boiler Retrofit;

FIG. 32 is a view of WSHP CT VFD tab: User Inputs “Inventory Only” to “CT Make/Model”;

FIG. 33 is a view of WSHP CT VFD tab: User Inputs “Number of Units” to “Total Measure Cost”;

FIG. 34 is a view of Inventory and Savings Calculations of WSHP CT VFD;

FIG. 35 is a view of WSHP CWP VFD Tab: User Inputs “Inventory Only” to “Make/Model”;

FIG. 36 is a view of WSHP CWP VFD Tab: User Inputs “Number of Units” to “Total Measure Cost”;

FIG. 37 is a view of Inventory and Savings Calculations of WSHP CWP VFD;

FIG. 38 is a view of Temp Setbacks Tab: User Inputs “Building Type” to “Number of Units”;

FIG. 39 is a view of Temp Setbacks Tab: User Inputs “Age of Installed Unit” to Thermostat Setpoints”;

FIG. 40 is a view of Inventory of HVAC units recommended for Temperature Reset;

FIG. 41 is a view of Refrigerant Recharge Tab: User Inputs “Building Type” to “Make/Model”;

FIG. 42 is a view of Refrigerant Recharge Tab: User Inputs “Number of Units” to “Total Measure Cost”;

FIG. 43 is a view of Inventory of HVAC Units Recommended for Refrigerant Recharge;

FIG. 44 is a view of CO Sensor on Pkg Garages Tab: “Non-Inventory” user inputs;

FIG. 45 is a view of CO Sensors on Pkg Garages tab: “Inventory Only” user inputs;

FIG. 46 is a view of Inventory of Parking Garages recommended for CO Sensor Installation;

FIG. 47 is a view of VFD on Kitchen Exhaust Tab: User Inputs “Inventory Only” to “Affinity Law Factor”;

FIG. 48 is a view of VFD on Kitchen Exhaust Tab: User Inputs “Operating Schedule” to “Total Measure Cost”;

FIG. 49 is a view of Inventory of Kitchen Exhaust Units recommended for VFD Installation;

FIG. 50 is a view of HVAC Efficiency Improvement Savings Summary on Results tab;

FIG. 51 is a view of HVAC Efficiency Improvement Savings Summary Report: Initially Unpopulated;

FIG. 52 is a view of Press “Save and Continue” button on HVAC Inventory tab to populate a blank report with values;

FIG. 53 is a view of HVAC Efficiency Improvement Savings Summary Report with Populated Data;

FIG. 54 is a view of Water Heating Input Tab: User Inputs “Inventory Only” to “DHW Gas Utility Incentive”;

FIG. 55 is a view of Water Heating Input Tab: User Inputs “Wrap Electric Utility Incentive” to “Total Wrap Measure Cost”;

FIG. 56 is a view of Water Heating Inventory Tab;

FIG. 57 is a view of Water Heating Results Tab;

FIG. 58 is a view of Water Heating Reports tab;

FIG. 59 is a view of Water Heating Pictures Tab;

FIG. 60 is a view of Auto Door Closers Tab: User Inputs;

FIG. 61 is a view of Inventory of Walk-Ins Recommended for Auto Door Closers;

FIG. 62 is a view of Door Gasket EEM Tab: User Inputs;

FIG. 63 is a view of Inventory of Coolers Recommended for Door Gaskets;

FIG. 64 is a view of HE Ice Maker Tab: User Inputs;

FIG. 65 is a view of Inventory of HE Ice Makers Recommended for Retrofit;

FIG. 66 is a view of Strip Curtains Tab: User Inputs;

FIG. 67 is a view of Inventory of Coolers Recommended for Strip Curtains;

FIG. 68 is a view of Various user inputs required for VFD on Evap Fans tab;

FIG. 69 is a view of Evaporator Fans Recommended for VFDs;

FIG. 70 is a view of Refrigeration retrofit/upgrade Savings Summary on Results tab;

FIG. 71 is a view of Door Gasket Retrofit Savings Summary Report Initially Unpopulated;

FIG. 72 is a view of Press “Save & Continue” button on Door Gasket EEM tab to populate blank report with values;

FIG. 73 is a view of Door Gasket EEM Savings Summary Report with populated data;

FIG. 74 is a view of Plug Load: ES Prints: User Inputs;

FIG. 75 is a view of ES Printers Recommended for Replacement;

FIG. 76 is a view of Other Results Tab;

FIG. 77 is a view of Other Reports Tab;

FIG. 78 is a view of Various user inputs required for Input and Inventory tab;

FIG. 79 is a view of Inventory of Water Fixtures Recommended for Replacement;

FIG. 80 is a view of Water Conservation Results Tab;

FIG. 81 is a view of a Water Conservation Summary Report initially unpopulated;

FIG. 82 is a view of Press “Save and Continue” button on Input and Inventory Tab to populate a blank report with values;

FIG. 83 is a view of Water Conservation Summary Report with populated data;

FIG. 84 is a view of Renewables Input Tab;

FIG. 85 is a view of Inventory for Renewables;

FIG. 86 is a view of Renewables Results Tab;

FIG. 87 is a view of Renewables Report Tab; and

FIG. 88 is a schematic view of an energy audit tool.

### DETAILED DESCRIPTION OF EMBODIMENTS

As discussed above, embodiments of the present invention relate to an energy audit tool that includes an on-site and secure web-based application tool (with https and SSL) for performing IDSM audits.

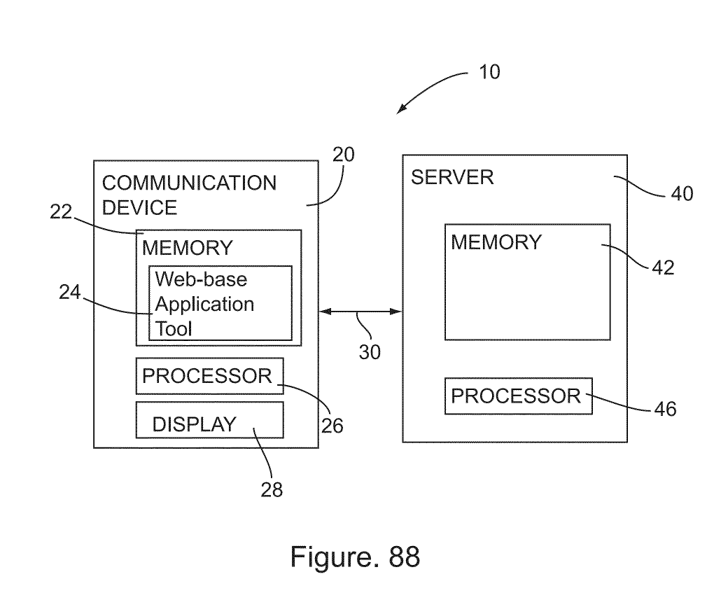

Referring to FIG. 88, embodiments of the invention include an energy audit tool 10 that comprises a communication device 20 and a server 40, wherein the communication device 20 is in communication with the server 40 through connection 30. The communication device 20 may be a mobile computing device, such as, but not limited to, a smart phone, a personal digital assistant, a tablet, a laptop, a desktop computer located onsite, or any similar type of device. The communication connection 30 includes any type of network connection that allows for Internet connectivity. For example, and without limitation, the network connection may be wireless connection, a wired connection, a Wi-Fi connection to a wired system, a LAN, a WAN or the like.

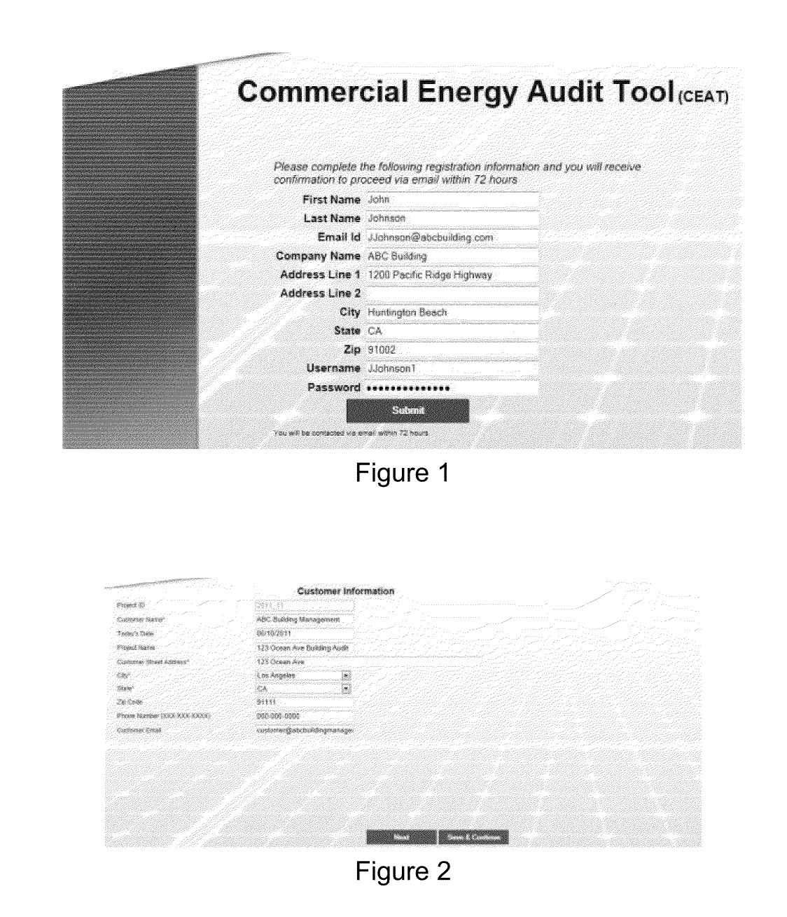

The audit tool 10 further comprises an onsite secure web-based application tool 24, wherein the onsite tool 24 is operable on the communication device 20, and wherein the onsite tool 20 provides access to information stored on a memory 42 of the server 40. The onsite tool 24 is operable on various platforms and operating systems. For example, the onsite tool may be operable on a Windows operating system, an Apple operating system, an Android operating system, a Blackberry operating system, or any other type of operating system. The onsite tool 24 may be stored in a memory 22 of the communication device 20. The onsite tool 24 provides instruction that are executed by the processor and displays information that is to be entered in a user interface (as depicted in FIGS. 1-87) on a display 28 of the communication device 20.

Embodiments of the audit tool 10 comprise several different features. One feature includes energy efficiency measures (hereinafter “EEMs”). For example, the audit tool provides for standardized energy engineering calculations with supporting references, keeps inventory of all energy consuming items at a site being audited, covers all EEMs for commercial buildings less than or equal to 120,000 square feet, and for facilities with a central plant, allows for the collection of equipment inventory for later use.

Prior to performing audits, the audit tool allows for a setting up process. An auditor may first register by performing the following:

1) Visit a website and accessing the a registration page.

2) Click on the “Register” link in the upper right-hand corner of the page.

3) Enter your contact information as requested (see FIG. 1).

4) Create a Username and Password.

5) Press the “Submit” button.

6) After pressing “Submit”, a notification will be sent to the web tool administrator for approval. (Please note that approval can take up to five days for processing.)

7) Once you have been notified that your profile has been approved, you will be able to log in from the home page with your Username and Password to easily use the system.

Please Note: You will only be allowed to use the modules that you have purchased once your User Profile is approved. Please Note: You will only be allowed to use the modules that you have purchased once your User Profile is approved. The present version of the tool works effectively with version 9 of Internet Explorer. Based on the feedback from the users, regular updates are expected for this tool and hence it is recommended to clear history, cookies and cache of the browser using CCleaner software for the updates to be effective.

1) FIG. 1: Example of Contact Information Input Page

Once registered, an auditor may begin using the audit tool.

The Home Page lists all existing customers and contains the link to create a new customer.

Customer Info Tab

The Customer Info tab allows you to set up your account (see FIG. 2). Data-entry fields on this page include:

1) Project ID: This is automatically generated by the CEAT.

2) Customer Name

3) Date: The CEAT automatically inserts this date, but it can be changed, if needed.

4) Project Name: This is not required, however it is useful for customers with multiple projects.

5) Customer Address

6) Phone Number

7) Customer Email

Utility Info Tab

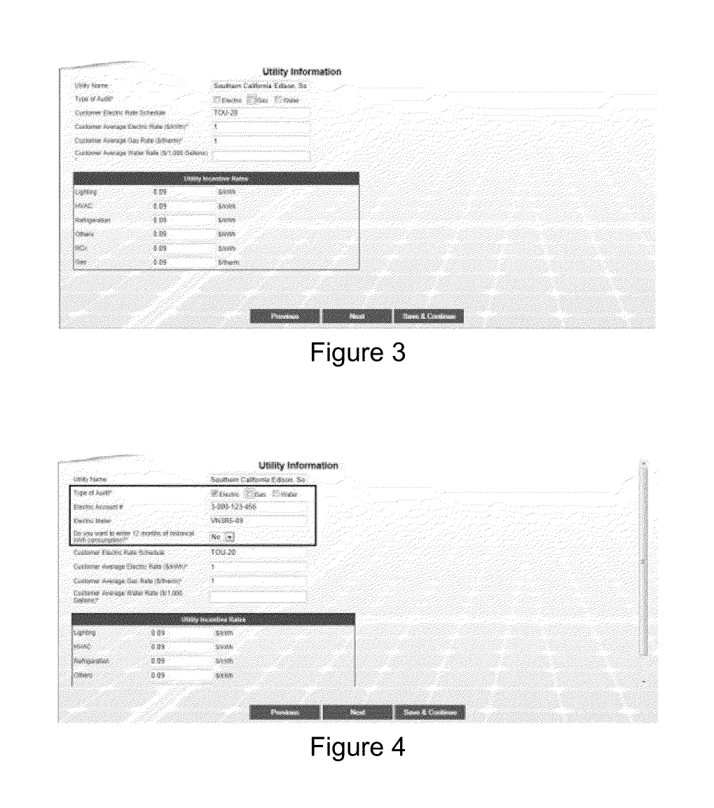

The Utility Info tab allows you to enter the customer's unique utility usage information (see FIG. 3) and contains the following data entry fields:

1) Utility Name

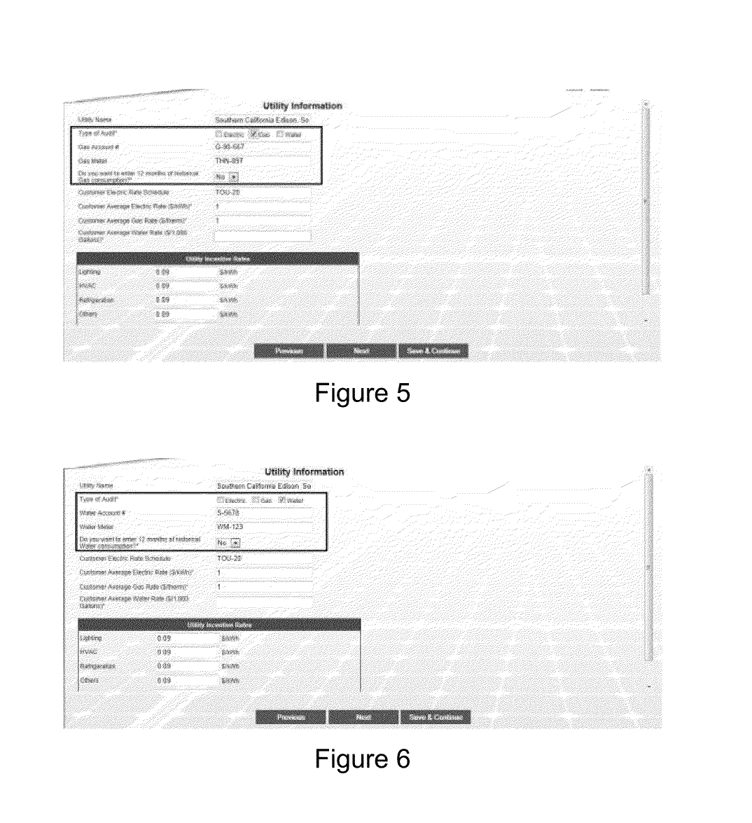

2) Type of Audit: You may select one type, two types, or all three types. When you select any type of audit, the screen will expand to include additional inputs specific to the type of audit being performed (see FIGS. 4, 5, and 6 for examples). The types of audits that can be performed include: a. Electric, b. Gas, and c. Water. (See FIGS. 4-6).

3) Electric/Gas/Water Account #

4) Electric/Gas/Water Meter: This It is the utility meter number for the facility.

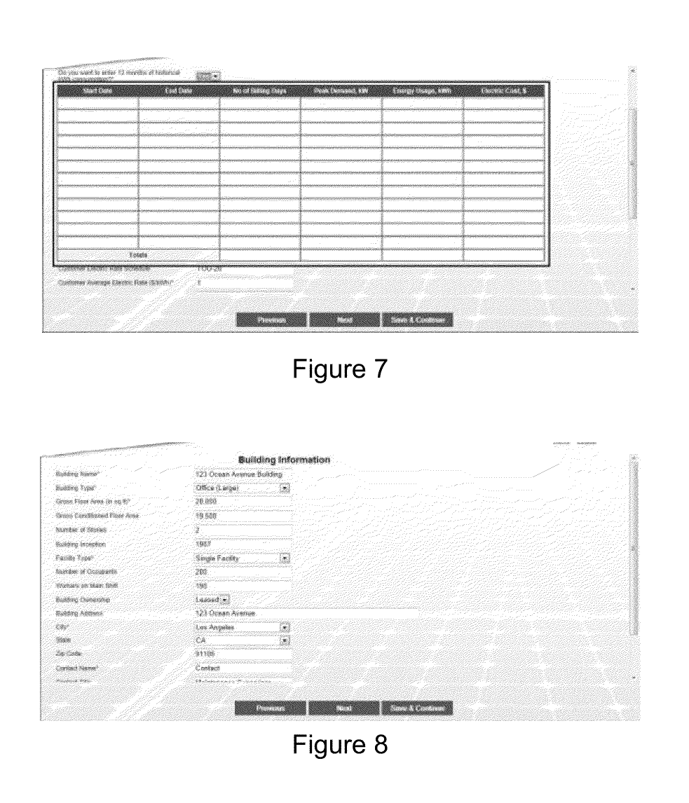

5) Do you want to enter 12 months of historical kWh consumption?: This requires a yes or no answer. You may choose not to include this; however, historical data is useful in determining how closely your baseline kWh usage reflects actual building energy consumption. If you select “NO”, move on to the next field. If you select “YES”, a table will appear for you to enter the customer billing information for the past 12 months (see FIG. 7).

6) Customer Electric Rate Schedule: This is the electric rate structure for the customer.

7) Customer Average Electric/Gas/Water Rate

8) Utility Incentive Rates: These are the incentive rates that the customer's utility(ies) offer. They will be used in the utility incentive estimation calculations. If the customer does not offer incentives for a particular input, it may be left blank or entered as $0.00. The types of utility incentives used in the CEAT are as follows: a. Lighting, b. HVAC, c. Refrigeration, d. Others, e. RCx (Retrocommissioning), and f. Gas.

Building Info Tab

The Building Info tab allows you to enter the required building information (see FIG. 8).

The data entry fields for this tab are as follows:

1) Building Name

2) Building Type

3) Gross Floor Area (entered in square feet)

4) Gross Conditioned Floor Area (entered in square feet): input is used for benchmarking and is not used in calculations.

5) Number of Stories: input is used for benchmarking and is not used in calculations.

6) Building Inception

7) Facility Type: This input allows you to select if the number of buildings on site.

8) Number of Occupants

9) Workers on Main Shift

10) Building Ownership

11) Building Address

12) Contact Name

13) Contact Title

14) Contact Phone

15) Contact Email

16) Energy Efficiency Measures: This input allows you to select the energy efficiency measures taken into consideration when the building audit was performed.

Building Architecture Tab

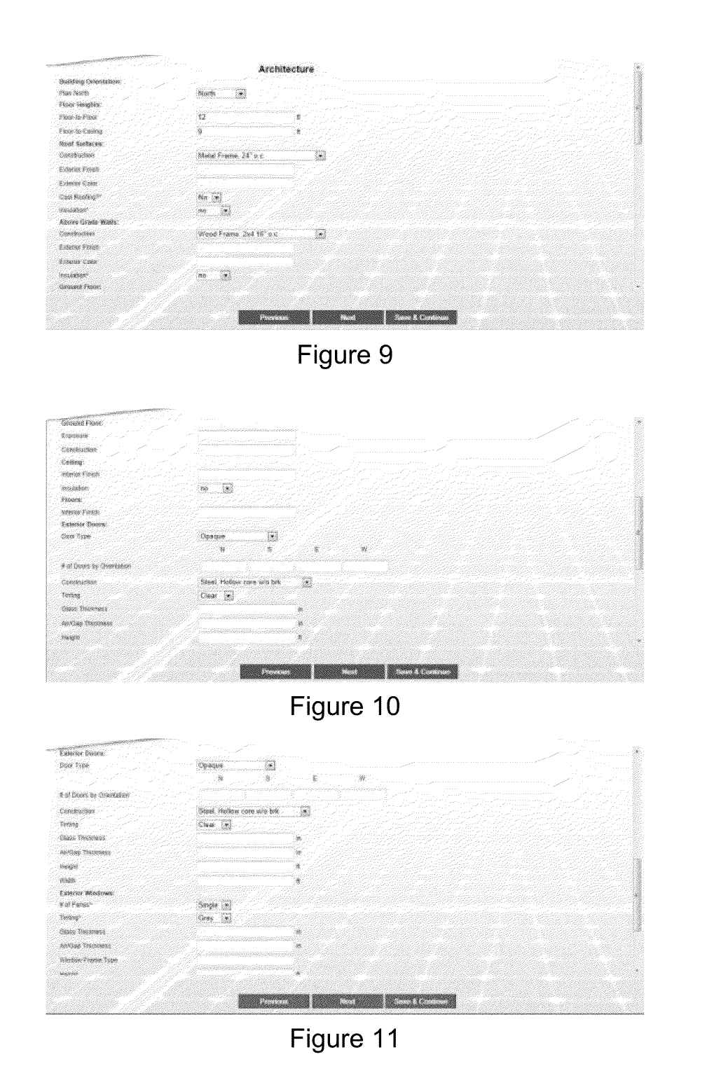

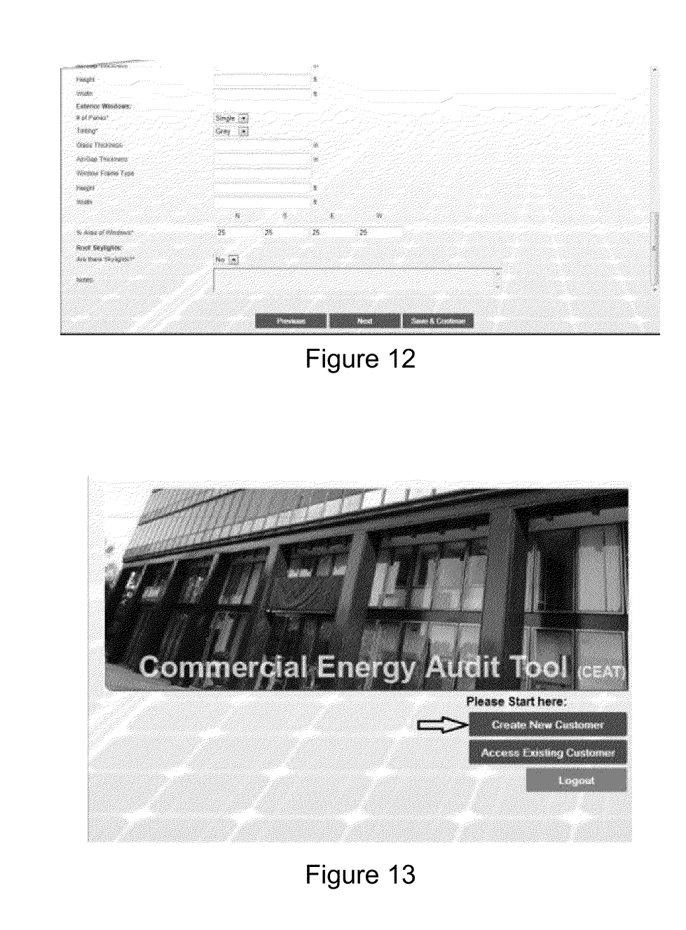

The Building Architecture tab allows you to input specific building architecture information (see FIGS. 9, 10, 11, and 12).

The data entry fields for this tab are as follows:

1) Plan North: This is the direction of the front of the building.

2) Floor-to-Floor Height:

3) Floor-to-Ceiling Height (Note: May be the same as the floor-to-floor height in some cases.)

4) Roof Construction: This input refers to the way the roof is constructed.

5) Exterior Roof Color: This input is used to determine the solar absorptance.

6) Cool Roofing (Note: A cool roof will have a lower Albedo value.)

7) Roofing Insulation:

8) Above Grade Wall Construction: This input refers to the way the walls are constructed.

9) Above Grade Wall Exterior Finish: This input is used to determine the solar absorptance.

10) Above Grade Exterior Color: This input is used to determine the solar absorptance.

11) Above Grade Wall Insulation

12) Ground Floor Exposure: This input refers to what type of material the ground floor is exposed to (i.e. earth contact, over parking garage, over crawlspace, etc.)

13) Ground Floor Construction: This input refers to how the ground floor is constructed.

14) Ceiling Interior Finish

15) Ceiling Insulation

16) Floor Interior Finish

17) Exterior Door Type

18) # of Doors by Orientation: This input is the number of doors on each side of the building. The orientations are broken into North, South, East, and West. If the building North is a direction other than north, the CEAT will take the orientations of the doors into account.

19) Door Construction

20) Door Tinting

21) Door Glass Thickness

22) Door Air/Gap Thickness: This input only applies to doors that are double paned glass.

23) Door Height

24) Door Width

25) # of Exterior Window Panes

26) Window Tinting

27) Window Glass Thickness

28) Window Air/Gap Thickness: This input only applies to windows that are double paned.

29) Window Frame Type

30) Window Height

31) Window Width

32) % Area of Windows: This input is the percentage of total window area on each side of the building. The orientations are broken into North, South, East, and West. If the building North is a direction other than north, the CEAT will take the orientations of the window areas into account.

33) Are There Roof Skylights?

34) % Coverage of Roof Skylights

35) # of Skylights

36) Typical Skylight Width

37) Typical Skylight Height: This input is not required.

38) Skylight Configuration: This input is not required.

39) Skylight Glazing Type: This input is not required.

B. Create a New Customer or Building

Create a New Customer

You may create a new customer entry for a customer with one or multiple buildings. To create a new customer, follow these steps:

1) Log onto the CEAT at http://lincusenergyauditor.com/Lincus.

2) Click the “Create New Customer Link” on the Home Page (see FIG. 13).

3) Fill out all required information on the Customer Info tab. When you are finished, click on the “Save and Continue” button.

4) Fill out all required information on the Utility Info tab. When you are finished, click on the “Save and Continue” button.

5) Fill out all required information on the Building Info tab. When you are finished, click on the “Save and Continue” button.

6) Fill out all required information on the Architecture tab. When you are finished, click on the “Save and Continue” button. You will then be taken to the Lighting tab to begin entering audit information.

Create a New Building for an Existing Customer

If your customer has multiple buildings, please create a “New Building for an Existing Customer” to keep buildings grouped together and easy to review.

1) Click on the “Home” link. (You may do this from whatever tab or customer you are currently viewing.)

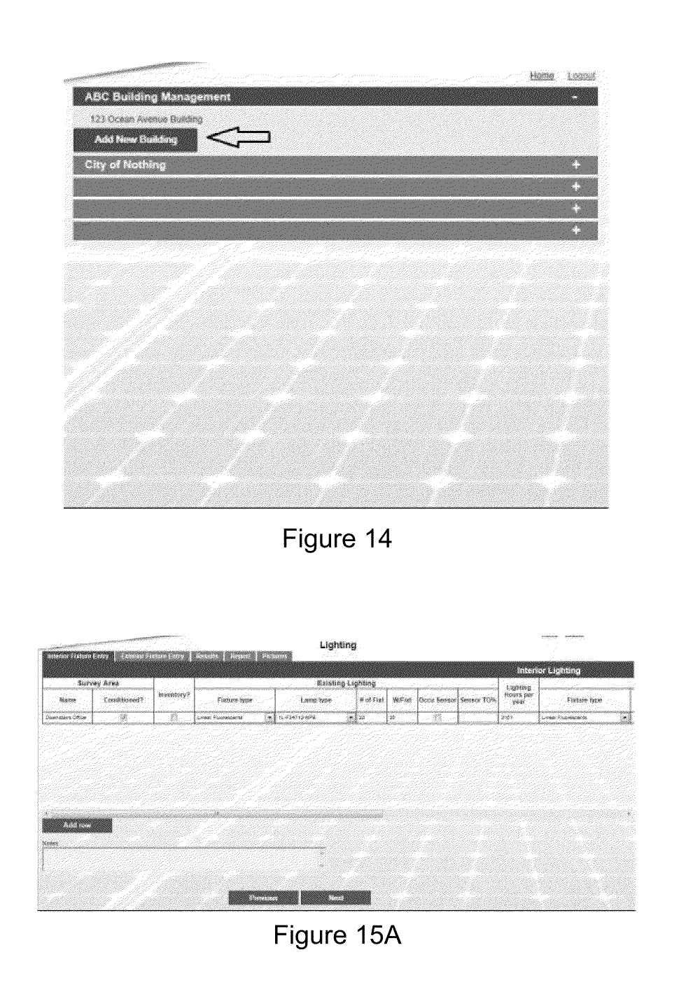

2) Select the “Add New Building” link under the customer for which you would like to create a new building (see FIG. 14).

3) Edit any information on the Customer Info tab as necessary. When you are finished, click on the “Save and Continue” button.

4) Fill out all required information on the Utility Info tab. When you are finished, click on the “Save and Continue” button.

5) Fill out all required information on the Building Info tab. When you are finished, click on the “Save and Continue” button.

6) Fill out all required information on the Architecture tab. When you are finished, click on the “Save and Continue” button. You will be taken to the Lighting tab to begin entering audit information.

Please Note: You may repeat steps 1-6 as many times as required to create the needed number of building entries for a customer.

Further, embodiments of the audit tool performs audit functions related to prescriptive measures and comprise a plurality of modules, wherein the audit tool includes the applicable commercial measures within the available modules. Modules of the onsite tool related to prescriptive measures includes, but is not limited to, a lighting module, an HVAC module, a Water Heating module, a Refrigeration module, a Water Conservation module, a Renewables module, a PC Power Management module, a Variable Frequency Drives (“VFD”) on Evaporative Fans and Pumps module, a VFD on Kitchen Exhaust Fans module, a Plug Load Occupancy Sensor module, an Auto Door Closer module, an High Efficiency Cooking Equipment module, an High Efficiency Ice Maker module, and a Vending Misers module. Other modules may also be incorporated for use in a commercial audit.

### Lighting Module

The lighting module is accessible from the onsite tool. A user interface indicates to an auditor that he or she has accessed the lighting module. The lighting module interface provides several tabbed screens that allow for input of information relating to lighting. The lighting module covers the retrofit of both interior and exterior lighting. Its calculations take into account the baseline energy usage and proposed energy usage, as well as the effects of occupancy sensors and lighting on HVAC systems.

There are several features of a Lighting Module. One feature includes updating a database with the lighting operational hours so that the auditor will only have to select the building type for the operational hours to be selected. Another feature of the Lighting Module includes providing for identification of the prescriptive versus custom type lighting measures based on user selections on the “Incentive Type” ($/kWh for custom and $/fixture, $/lamp for prescriptive) as typically asked by the utility program policies. Additionally, the Lighting Module further includes prescriptive measures within the lighting module will be identified within the tool based on the user selection for the “Incentive Type” drop down box. The default selection on the incentive type will be “$/kWh” (custom) but the users can change the incentive type from the drop down box as “$/lamp” or “$/fixture” in which case, the particular measure will be validated as prescriptive by the audit tool. The audit tool will display the customer annual energy savings for all prescriptive measures.

The Lighting Module may include program baseline wattage for certain applicable custom lighting fixtures. A mapping routine is also present for interior and exterior fixtures to determine the program baseline on which the “Program Reportable Savings” for the custom lighting measures will be calculated.

The Lighting Module also incorporate accounting for occupancy sensor type and number of sensors as user entries within the audit tool for the users to evaluate the occupancy sensor measures. Calculation of customer annual energy savings and prescriptive incentives is performed consistent with an express measure list. This may include a results table for prescriptive lighting measures, as well as the integration of the prescriptive and custom measure individual reports into the final report.

It will be understood that all of the input and data collected by the lighting module operates onsite and through the onsite tool. Further, while specific types of information is disclosed as being collected in this embodiment, other types of information regarding lighting may also be collected by use of the lighting module of the onsite tool.

On particular example of a Lighting Module may include:

A. Energy Efficiency Measures (EEMs) Covered

The Lighting Module covers the retrofit of both interior and exterior lighting. Its calculations take into account both the baseline energy usage and proposed energy usage, as well as the effects of occupancy sensors and lighting on HVAC systems.

Interior Lighting Retrofit: This EEM covers the retrofit of any fixtures installed on the interior of the building.

Exterior Lighting Retrofit: This EEM covers the retrofit of any fixtures installed on the exterior of the building.

B. User Inputs

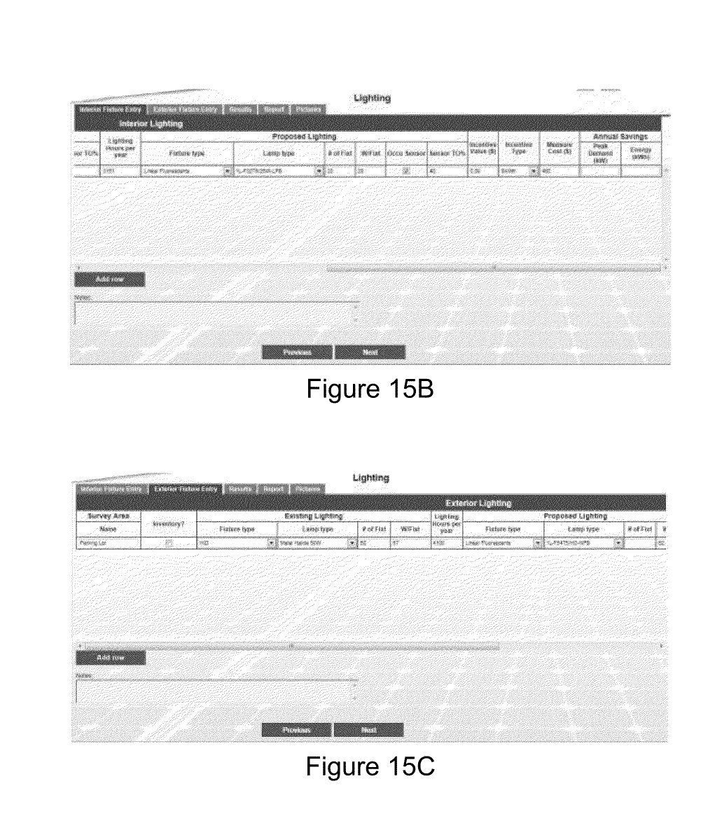

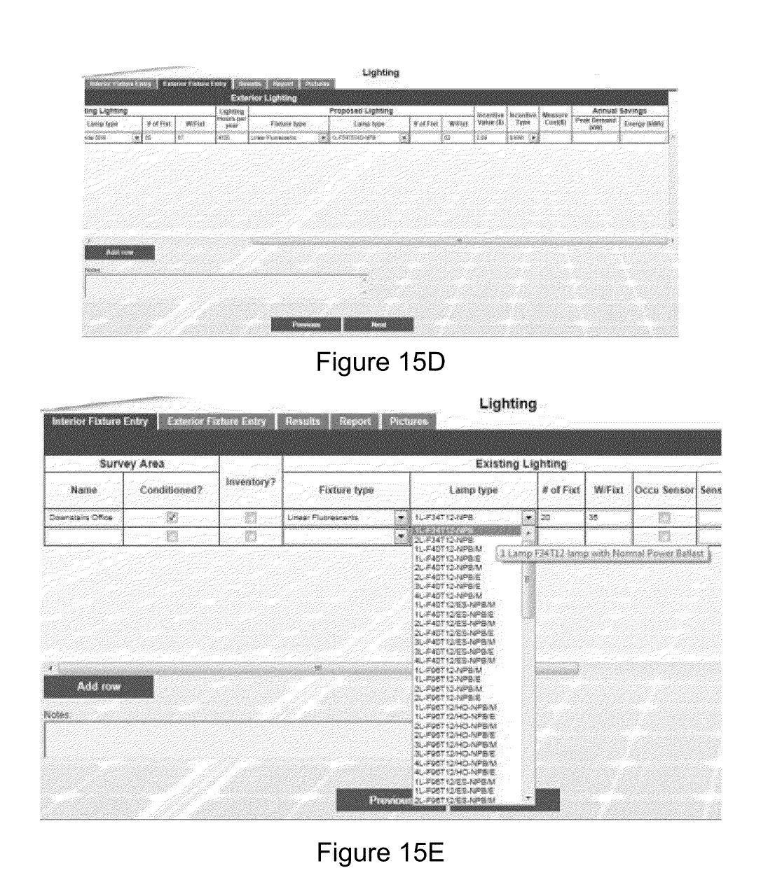

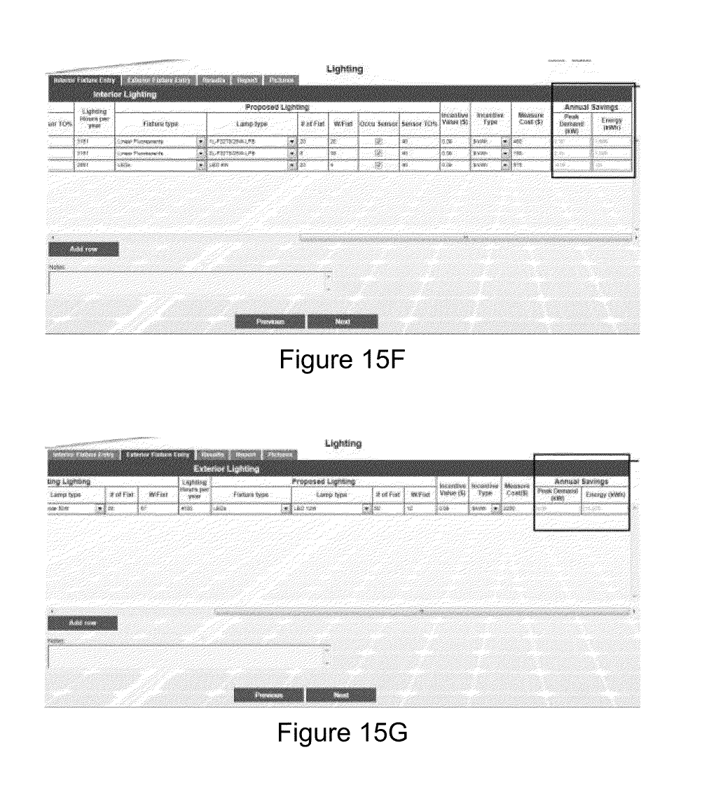

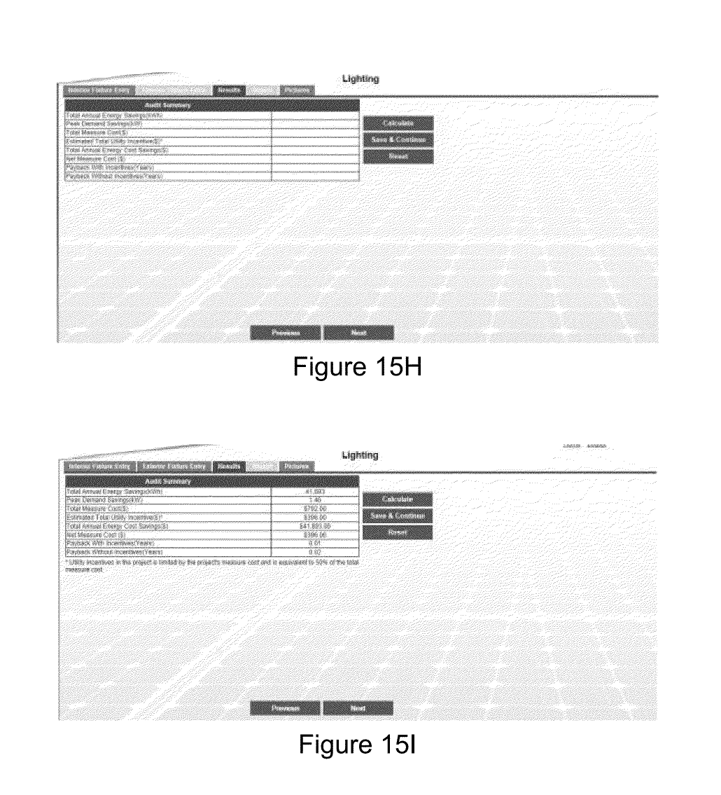

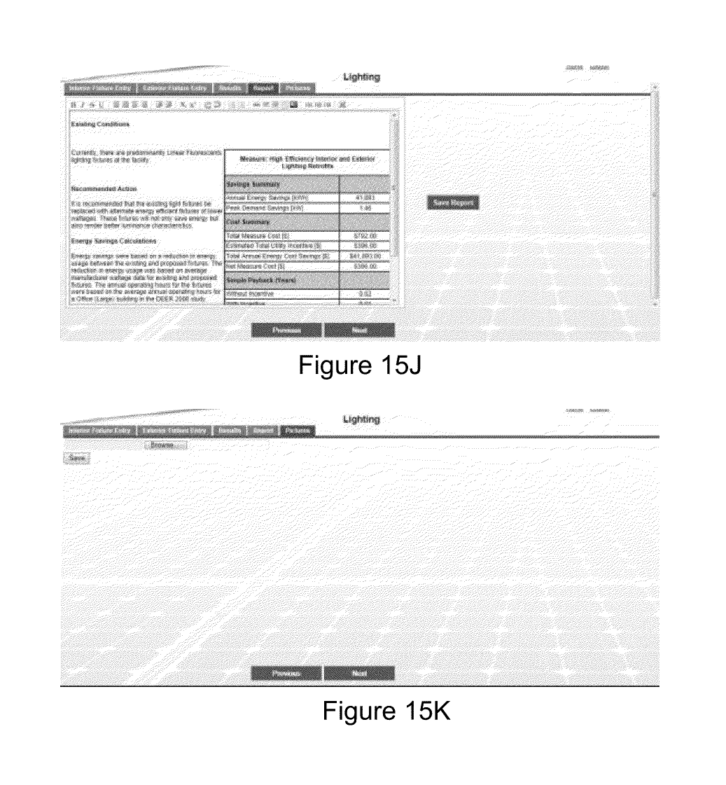

These are the inputs needed to supply the CEAT with the information needed to calculate savings and incentive numbers, and should be entered on the Interior Fixture Entry tab and the Exterior Fixture Entry tab (see FIGS. 15A, 15B, 15C, and 15D).

User Input List

Most of the user input information listed below can be found on both the Interior Fixture Entry tab and the Exterior Fixture Entry tab. The exceptions to this rule are “Conditioned?,” “Occu Sensor,” and “Sensor TO %” which do not appear on the Exterior Fixture Entry tab, as they do not apply.

1) Survey Area Name

2) Conditioned?

3) Inventory?: Input if the proposed fixtures that are coming out of the building's inventory if they do not need to be acquired.

4) Existing Fixture Type

5) Existing Lamp Type (Note: If you move the cursor over the lamp type, an explanation will appear—see FIG. 15E.)

6) Existing # of Fixt:: Input the number of existing fixtures that use the existing lamp type.

7) Existing W/Fixt: input the Watts per fixture. The CEAT will automatically populate this field with the typical value, but this value can be changed if needed.

8) Existing Occu Sensor: Input of the existing fixtures have occupancy sensors.

9) Existing Sensor TO %: This is the percentage of time the occupancy sensor turns the existing connected lights off, and is not required.

10) Lighting Hours Per Year: The CEAT automatically populates this field based on the building type and is required information. It may be customized, if needed.

11) Proposed Fixture Type

12) Proposed Lamp Type

13) Proposed # of Fixt

14) Proposed W/Fixt (Note: The CEAT will automatically populate this field with the typical value, and if can be changed if needed.)

15) Proposed Occu Sensor: Input if the proposed fixtures have occupancy sensors.

16) Proposed Sensor TO %: Input the percentage of time the occupancy sensor turns the proposed connected lights off.

Please Note: Annual Savings will remain blank until all savings have been calculated, after which this field will automatically populate with itemized savings for each survey area (see FIGS. 15F and 15G).

C. Results

The Results tab contains vital calculated information for the entire building. Initially, this tab will remain blank until all required data has been entered and you press the “Calculate” button, after which the fields will automatically calculate and populate the chart (see FIGS. 15H and 15I).

1) The following information will be calculated:

2) Total Annual Energy Savings [kWh]

3) Peak Demand Savings [kW]

4) Total Measure Cost [$]

5) Estimated Total Utility Incentive [$] (Note: This will be limited to 50% of the total measure cost.)

6) Total Annual Energy Cost Savings [$]

7) Net Measure Cost [$]

8) Payback with Incentive [Years]

9) Payback without Incentive [Years]

D. Report

The Report tab generates a boiler plate report and inserts the Results information into a table (see FIG. 15J). This report can be manipulated and saved.

E. Pictures

The Pictures tab allows you to insert key pictures taken during the on-site audit into the electronic file. These pictures can be used for audit reports in the future (see FIG. 15K).

### HVAC Module

The HVAC Module covers HVAC retrofit, schedule change, economizer retrofit, demand control ventilation, economizer retro-commissioning, water source heat pump boiler retrofit and variable frequency drive (VFD) on cooling tower, temperature reset, refrigerant recharge, and ventilation measures pertaining to HVAC systems.

With regard to HVAC retrofit, the HVAC Efficiency Improvement can be measured. This measure refers to the replacement of existing package units with units of higher efficiency. The SEER or EER value of a unit is the measure of its efficiency. The efficiencies of package units degrade over time, therefore, units may be recommended for replacement if they have unsatisfactory SEER/EER values, or if they are past or close to their expected useful life.

With regard to schedule change, an Energy Management System (EMS) Installation measure refers to the installation of a system to manage the operating schedule of the HVAC equipment. When HVAC units do not have this control, they operate 24/7 or they must be turned on and off manually by facilities personnel. With EMS equipment installed, energy is saved when the units are able to be turned off automatically.

An Economizer Retrofit measure refers to the installation of economizer(s) on HVAC systems which do not already have them in place. Economizers allow the cooling portion of HVAC systems to draw in more outside air than normal when outside temperatures are low enough. When outside air is cooler than return air from a building, it is more efficient to use cooler outside air then to mechanically cool the return air.

A Demand Control Ventilation (DCV) Retrofit measure refers to the installation of CO2 sensors on return air ducts in order to supply the minimum amount of outside air circulation necessary for the number of occupants currently in the building. Otherwise, the HVAC system will supply the amount of outside air circulation required for the square footage of the building; when there are very few occupants, this amount of circulation will be greater than what is required by the occupants.

An Economizer Retro-commissioning (RCx) measure refers to the repair of economizers that are not working properly. If an economizer is stuck in one position, it will not provide the energy savings it should, and, in fact, it may cause an HVAC system to use more energy.

The onsite tool handles a Water Source Heat Pump (WSHP) Condenser Water (CW) Loop in such a way as to calculate savings from three types of WSHP CW loop measures:

1) Water Source Heat Pump (WSHP) Boiler Retrofit: This measure refers to the retrofit of a water source heat pump boiler with one that operates more efficiently. Higher efficiency of a boiler can be achieved through its change in type, its overall efficiency, or its capacity.

2) Water Source Heat Pump (WSHP) Cooling Tower VFD Installation: This measure refers to the installation of a VFD on a cooling tower fan for a water source heat pump. A VFD allows a cooling tower fan to run at lower speeds when less heat rejection is needed.

3) Water Source Heat Pump (WSHP) Condenser Water Pump VFD Installation: This measure refers to the installation of a VFD on a condenser water pump for a water source heat pump. The VFD allows a condenser water pump to run at lower speeds when less heat rejection is needed.

A Temperature Setbacks measure refers to the change in thermostat setting in a building, typically during unoccupied hours. A setback is a higher temperature during cooling times and a lower temperature during heating times. A setback requires the HVAC system to work less to achieve the desired building temperature.

A Refrigerant Recharge measure refers to the restoration of the proper amount of refrigerant in package HVAC units. Package HVAC units lose refrigerant charge over time, and as this happens, they work less efficiently.

A Ventilation measure of the onsite tool calculates savings from two types of ventilation measures:

1) Carbon Monoxide (CO) Sensors on Parking Garages: Parking garages are required to have exhaust fans on all underground levels to evacuate the Carbon Monoxide (a molecule found in vehicle emissions) from the underground levels. As a general rule, these fans are on 100% of the time. CO sensors allow the fans to turn on and off as needed when there are few or no cars in the garage and they do not need to be constantly running

2) Variable Frequency Drives on Kitchen Exhaust Fans: Kitchens are required to have exhaust fans to evacuate smoke, steam, and other fumes from the kitchen area. These fans are usually on at full speed whether needed or not. A variable frequency drive (VFD) allows the fans to run at slower speeds when they do not need to evacuate as much volume.

Further, auditors will be able to enter custom/prescriptive incentives for the different HVAC measures. In embodiments, federal tax credits for HVAC will be based on auditor selection, such as, for example, with a checkbox.

One particular example of an HVAC Module may include:

A. Energy Efficiency Measures (EEMs) Covered

The HVAC Module covers HVAC retrofit, schedule change, economizer retrofit, demand control ventilation, economizer retro-commissioning, water source heat pump boiler retrofit and variable frequency drive (VFD) on cooling tower, temperature reset, refrigerant recharge, and ventilation measures pertaining to HVAC systems.

HVAC Efficiency Improvement

This measure refers to the replacement of existing package units with units of higher efficiency. The SEER or EER value of a unit is the measure of its efficiency. The efficiencies of package units degrade over time, therefore, units may be recommended for replacement if they have unsatisfactory SEER/EER values, or if they are past or close to their expected useful life.

Energy Management System (EMS) Installation

This measure refers to the installation of a system to manage the operating schedule of the HVAC equipment. When HVAC units do not have this control, they operate 24/7 or they must be turned on and off manually by facilities personnel. With EMS equipment installed, energy is saved when the units are able to be turned off automatically.

Economizer Retrofit

This measure refers to the installation of economizer(s) on HVAC systems which do not already have them in place. Economizers allow the cooling portion of HVAC systems to draw in more outside air than normal when outside temperatures are low enough. When outside air is cooler than return air from a building, it is more efficient to use cooler outside air then to mechanically cool the return air.

Demand Control Ventilation (DCV) Retrofit

This measure refers to the installation of CO2 sensors on return air ducts in order to supply the minimum amount of outside air circulation necessary for the number of occupants currently in the building. Otherwise, the HVAC system will supply the amount of outside air circulation required for the square footage of the building; when there are very few occupants, this amount of circulation will be greater than what is required by the occupants.

Economizer Retro-Commissioning (RCx)

This measure refers to the repair of economizers that are not working properly. If an economizer is stuck in one position, it will not provide the energy savings it should, and, in fact, it may cause an HVAC system to use more energy.

Water Source Heat Pump (WSHP) Condenser Water (CW) Loop

The CEAT will calculate savings from three types of WSHP CW loop measures:

1) Water Source Heat Pump (WSHP) Boiler Retrofit: This measure refers to the retrofit of a water source heat pump boiler with one that operates more efficiently. Higher efficiency of a boiler can be achieved through its change in type, its overall efficiency, or its capacity.

2) Water Source Heat Pump (WSHP) Cooling Tower VFD Installation: This measure refers to the installation of a VFD on a cooling tower fan for a water source heat pump. A VFD allows a cooling tower fan to run at lower speeds when less heat rejection is needed.

3) Water Source Heat Pump (WSHP) Condenser Water Pump VFD Installation: This measure refers to the installation of a VFD on a condenser water pump for a water source heat pump. The VFD allows a condenser water pump to run at lower speeds when less heat rejection is needed.

Temperature Setbacks

This measure refers to the change in thermostat setting in a building, typically during unoccupied hours. A setback is a higher temperature during cooling times and a lower temperature during heating times. A setback requires the HVAC system to work less to achieve the desired building temperature.

Refrigerant Recharge

This measure refers to the restoration of the proper amount of refrigerant in package HVAC units. Package HVAC units lose refrigerant charge over time, and as this happens, they work less efficiently.

Ventilation

The CEAT calculates savings from two types of ventilation measures:

1) Carbon Monoxide (CO) Sensors on Parking Garages: Parking garages are required to have exhaust fans on all underground levels to evacuate the Carbon Monoxide (a molecule found in vehicle emissions) from the underground levels. As a general rule, these fans are on 100% of the time. CO sensors allow the fans to turn on and off as needed when there are few or no cars in the garage and they do not need to be constantly running

2) Variable Frequency Drives on Kitchen Exhaust Fans: Kitchens are required to have exhaust fans to evacuate smoke, steam, and other fumes from the kitchen area. These fans are usually on at full speed whether needed or not. A variable frequency drive (VFD) allows the fans to run at slower speeds when they do not need to evacuate as much volume.

B. User Inputs

User inputs are found on the Input, HVAC Inventory, WSHP Boiler Retrofit, WSHP CT VFD, Temp Setbacks, Refrigerant Recharge, and Ventilation tabs. The CEAT uses inputs from the Utility Info, Building Info, and Architecture tabs to perform calculations, so it is imperative that these tabs are filled out as required.

Input Tab

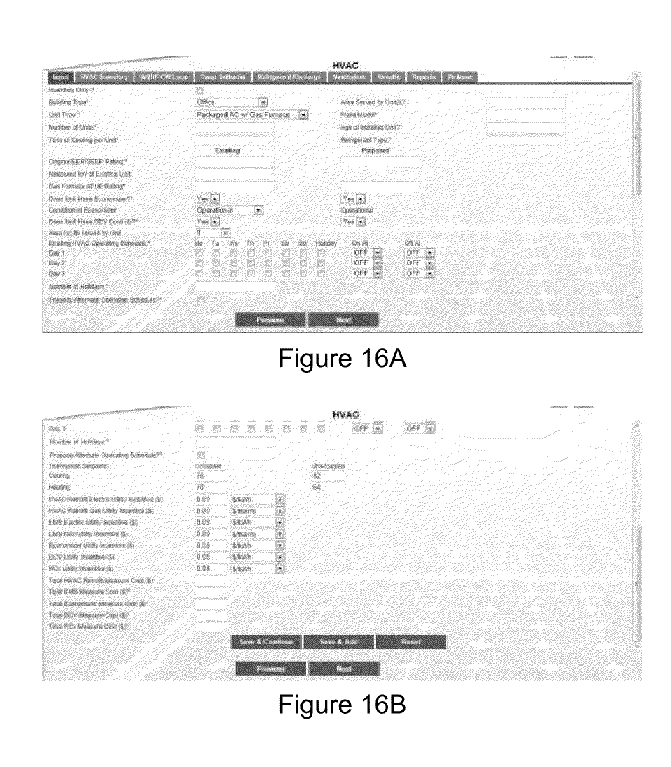

The inputs for the Input tab are used to calculate the following measures (See FIGS. 16A and 16B:

a. HVAC Efficiency Improvement; b. EMS Installation; c. Economizer Retrofit; d. DCV Retrofit; and e. Economizer RCx.

The user inputs for the Input tab are as follows:

1) Inventory Only?: Check this box if you are not recommending any of the above measures, and the equipment only needs to be entered in the building's HVAC inventory.

2) Building Type: This is the type of building the HVAC units are serving.

3) Unit Type

4) Number of Units: This is the number of units that all have the same information on the Input tab.

5) Tons of Cooling per Unit

6) Area Served by Unit(s)

7) Make/Model

8) Age of Installed Unit

9) Refrigerant Type

10) Existing Original EER/SEER Rating: This is the manufacturer EER/SEER rating of the existing unit at the time of installation (the CEAT will automatically degrade the efficiency rating based on the age of the unit).

11) Proposed Original EER/SSER Rating: This is the manufacturer EER/SEER rating of the proposed unit. This input is only required if the auditor is proposing a replacement unit (checking the “Inventory Only?” box signifies that a new unit is not being proposed).

12) Measured kW of Existing Unit: This is the measured kW of the existing unit, if a measurement has been performed. This input is not required. If a kW reading is entered, the CEAT will use this number within the calculations, instead of the degraded existing original EER/SEER rating.

13) Existing Gas Furnace AFUE Rating: This is the AFUE rating of the gas furnace on the existing unit. This input only appears on the input tab if “Packaged HP w/Gas Furnace” or “Split System AC w/Gas Furnace” is selected in the “Unit Type” drop down menu.

14) Proposed Gas Furnace AFUE Rating: This is the gas furnace AFUE rating of the proposed unit. This input only appears on the input tab if “Packaged HP w/Gas Furnace” or “Split System AC w/Gas Furnace” is selected in the “Unit Type” drop down menu.

15) Does Existing Unit Have Economizer?

16) Does Proposed Unit Have Economizer?

17) Condition of Economizer: This input is defaulted at operational and is required if there is an economizer.

18) Does Existing Unit Have DCV Controls?

19) Does Proposed Unit Have DCV Controls?

20) Area (sq. ft) Served by Unit

21) Existing HVAC Operating Schedule: (Note: Up to three different operating schedules can be made and at least one schedule is required. Both the days and hours of operation must be selected.

22) Existing Number of Holidays: This is the number of days that adhere to the existing HVAC holiday schedule.

23) Propose Alternate Operating Schedule?: Check this box if a new operating schedule or a different type of operating schedule control is proposed. If this box is checked, the EMS measure will be enabled and the proposed operating schedule inputs will appear on the screen.

24) Proposed Type of Schedule Control: This is the proposed equipment that will control the proposed HVAC schedule and will be used to determine the EMS measure cost.

25) Proposed HVAC Operating Schedule: This is the proposed operating schedule of the HVAC units. Up to three different operating schedules can be made and at least one schedule is required. Both the days and hours of operation must be selected.

26) Proposed Number of Holidays: This is the number of days that adhere to the proposed HVAC holiday schedule.

27) Occupied Cooling Thermostat Set Point: This is the thermostat set point when the building is occupied and the HVAC system is cooling the building.

28) Unoccupied Cooling Thermostat Set Point: This is the thermostat set point when the building is unoccupied and the HVAC system is cooling the building.

29) Occupied Heating Thermostat Set Point: This is the thermostat set point when the building is occupied and the HVAC system is heating the building.

30) Unoccupied Heating Thermostat Set Point: This is the thermostat set point when the building is unoccupied and the HVAC system is heating the building.

31) HVAC Retrofit Electric Utility Incentive: This is the electric utility incentive for the HVAC retrofit measure. It must be input in dollars [$]: i.e. [$/kWh], [$/ton], or [$/AC Unit].

32) HVAC Retrofit Gas Utility Incentive: This is the gas utility incentive for the HVAC retrofit measure. It must be input in dollars [$]: i.e. [$/therm].

33) EMS Electric Utility Incentive: This is the electric utility incentive for the energy management system installation measure. It must be input in dollars [$]: i.e. [$/kWh].

34) EMS Gas Utility Incentive: This is the gas utility incentive for the energy management system installation measure. It must be input in dollars [$]: i.e. [$/therm].

35) Economizer Utility Incentive: This is the electric utility incentive for the economizer retrofit measure. It must be input in dollars [$]: i.e. [$/kWh], or [$/economizer].

36) DCV Utility Incentive: This is the electric utility incentive for the demand control ventilation installation measure. It must be input in dollars [$]: i.e. [$/kWh] or [$/DCV].

37) RCx Utility Incentive: This is the electric utility incentive for the economizer retro-commissioning measure. It must be input in dollars [$] i.e. [$/kWh].

38) Total HVAC Retrofit Measure Cost: This is the estimated cost of an HVAC retrofit measure. The CEAT automatically populates this field if this measure was recommended, however, this number can be changed in needed. Input is required only if HVAC retrofits are involved.

39) Total EMS Measure Cost: This is the estimated cost of an EMS installation measure. The CEAT automatically populates this field if this measure was recommended, but this number can be changed if needed.

40) Total Economizer Measure Cost: This is the estimated cost of an economizer retrofit measure. The CEAT automatically populates this field if this measure was recommended, but this number can be changed if needed.

41) Total DCV Measure Cost: This is the estimated cost of a DCV installation measure. The CEAT automatically populates this field if this measure was recommended, but this number can be changed if needed.

42) Total RCx Measure Cost: This is the estimated cost of an economizer retro-commissioning measure. The CEAT automatically populates this field if this measure was recommended, but this number can be changed if needed.

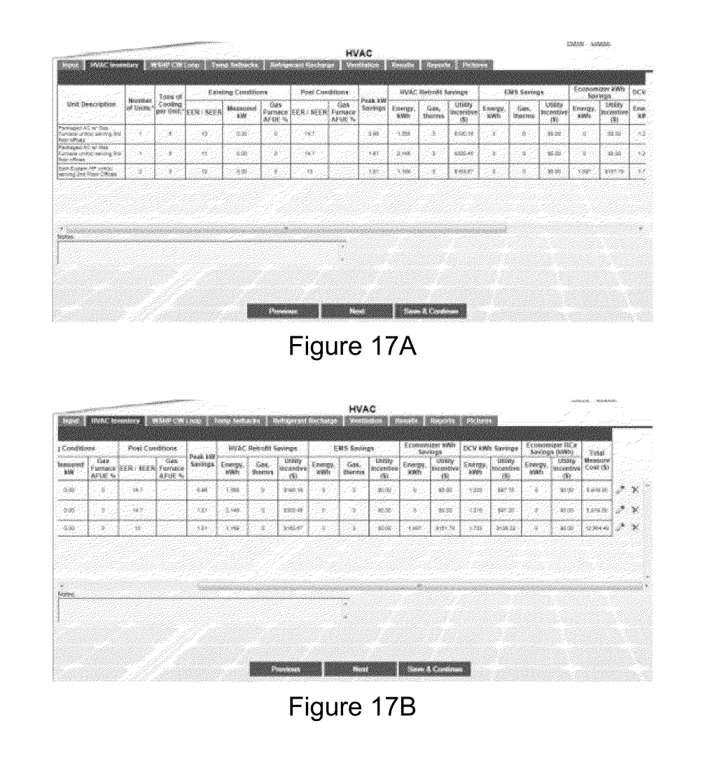

Once you are finished entering the user inputs on the HVAC Input tab, press the “Save and Add” button to store all of the information you have just entered to your internal cache regardless of whether or not you have an Internet connection. After your entries have been stored, all input fields will be cleared. When you are finished entering the data for all HVAC systems and are able to connect to the Internet, press the “Save and Continue” button again and all HVAC units you have entered will appear on the HVAC Inventory tab (see FIGS. 17A and 17B).

From the HVAC Inventory tab you may do four (4) things:

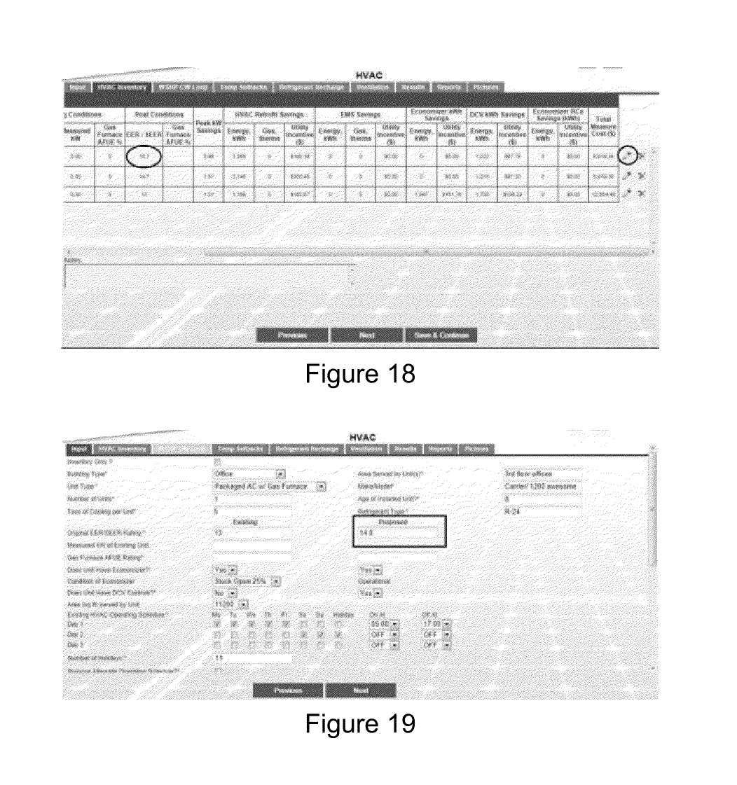

1) Edit an Existing HVAC Unit: Press the “Edit” button next to the unit you want to rework and you will be taken back to the Input tab where your previous entries will be re-populated (See FIG. 18).

a) Make any changes to the inputs that are needed (See FIG. 19).

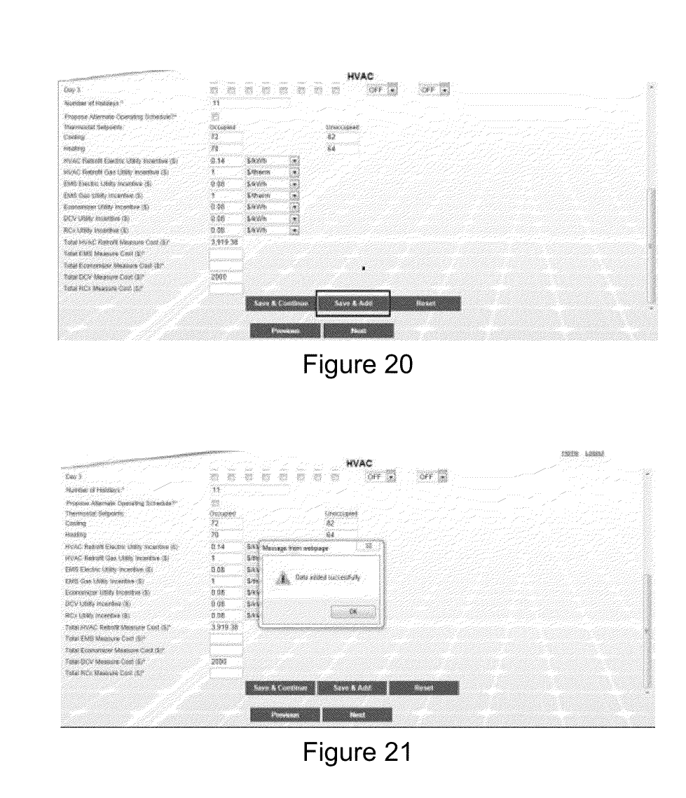

b) Press the “Save and Add” button (See FIG. 20).

c) A dialogue box will appear which says “Data Added Successfully” (See FIG. 21).

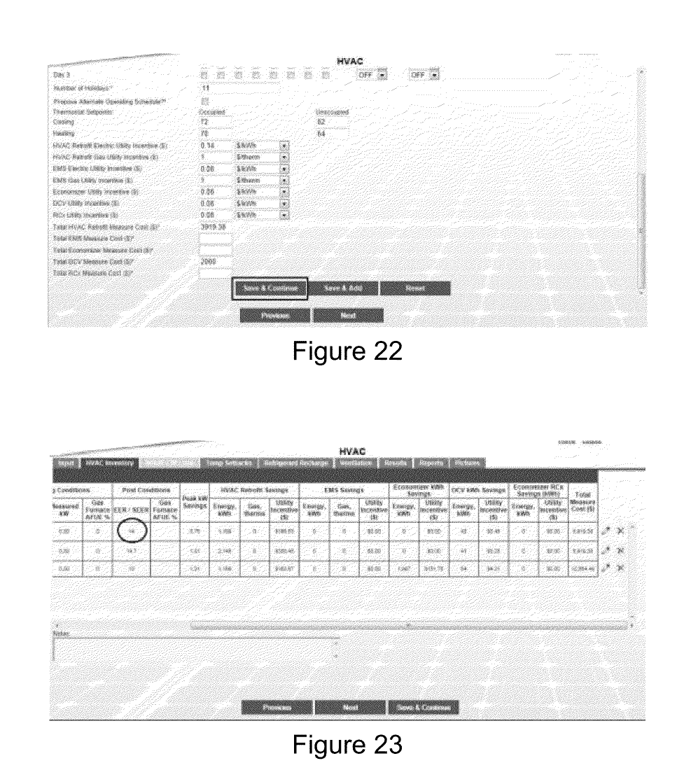

d) Press the “Save and Continue” button (See FIG. 22).

e) You will be taken back to the HVAC Inventory tab and the changes to the unit will have been saved (See FIG. 23).

Please note: If you press the “Save and Continue” button before you press the “Save and Add” button, you will be taken back to the HVAC Inventory tab and the changes made to the inputs will not be saved.

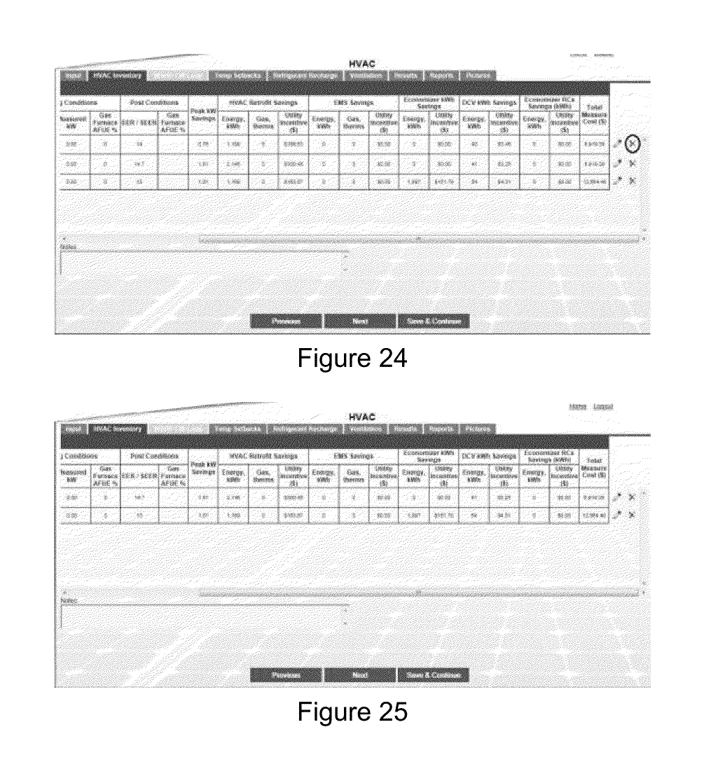

2) Remove a HVAC Unit from the Inventory: Press the “Remove” button (See FIG. 24).

a) The unit will be removed from the inventory (See FIG. 25).

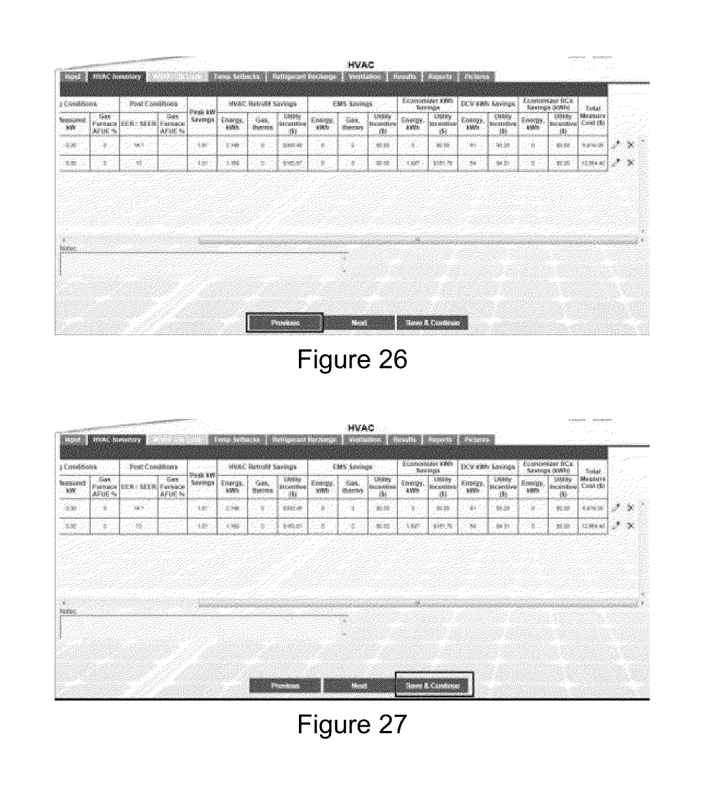

3) Continue to Input more HVAC Units: To continue entering information for more HVAC units, click on the Input tab and enter the required information (alternately, you may press the “Previous” button and this will take you back to the Input tab) (See FIG. 26).

4) Continue to Another Tab: Click on the “Save and Continue” Button (See FIG. 27). You will be taken to the WSHP Boiler Retrofit tab.

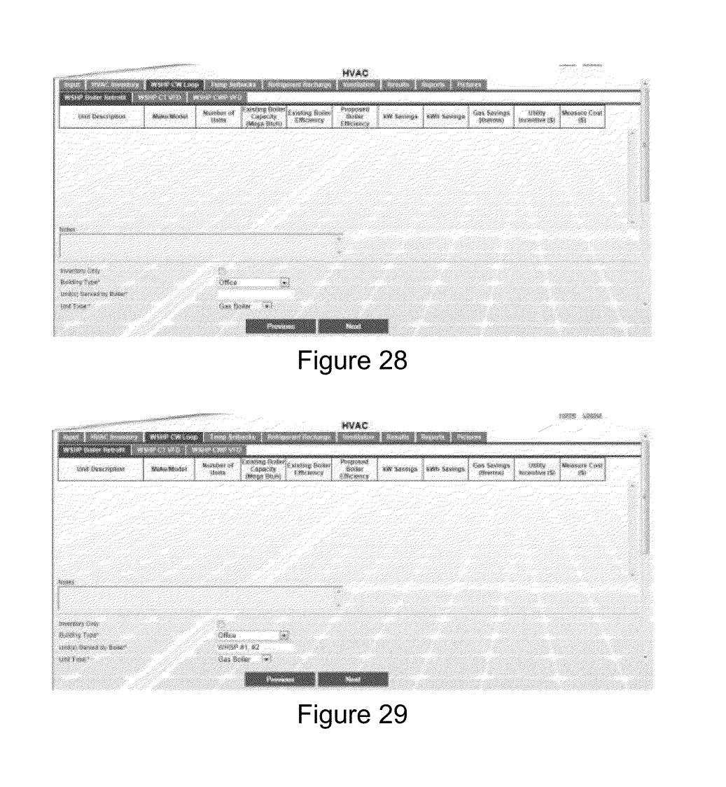

Please note: If you do not wish to edit the WSHP Boiler Retrofit tab, press the “Next” button to move onto the next tab (See FIG. 28). Alternately, you may press the name of the tab you want to edit. However, if you do not press “Save and Continue” any changes made to a tab will not be saved.

There are three sub-tabs under the WSHP CW Loop tab:

A. WSHP Boiler Retrofit: Inputs made under this tab are used for calculating energy savings for boiler retrofits.

B. WSHP CT VFD: Inputs made under this tab are used to calculate savings from the installation of a variable frequency drive (VFD) on cooling tower fans used for water source heat pumps (WHSPs).

C. WSHP CWP VFD: Inputs made under this tab are used to calculate savings from the installation of a variable frequency drive (VFD) on Condenser Water Pump used for water source heat pumps (WHSPs).

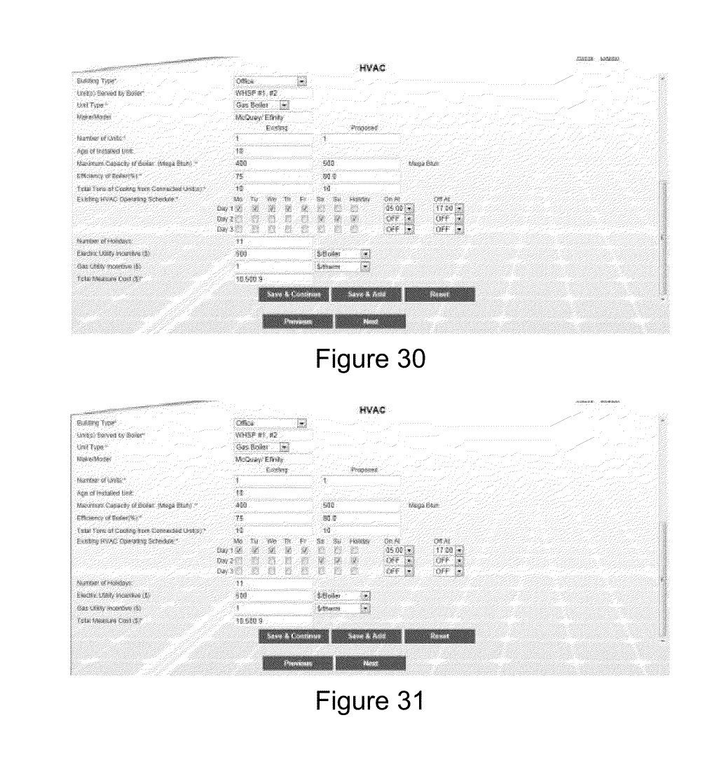

The inputs for the WSHP Boiler Retrofit tab are as follows (See FIG. 29-30):

1) Inventory Only?: Check this box if you are not recommending any of the measures and the equipment only needs to be entered into the building's Boiler inventory.

2) Building Type

3) Unit(s) Served by Boiler: This is the water source heat pump units that are served by the boiler.

4) Unit Type

5) Make/Model

6) Number of Existing Units: This is the number of existing units that all have of the same inputs.

7) Number of Proposed Units: This is the proposed number of units that all have of the same inputs.

8) Age of Installed Unit: This is the age of the unit since it was installed, regardless of its time in use.

9) Maximum Capacity of Existing Boiler: This is the maximum capacity of a single boiler (if there are more than one unit, multiple entries can be, made.)

10) Maximum Capacity of Propose Boiler: This is the maximum capacity of a single proposed boiler (if there are more than one unit, multiple entries can be made.)

11) Total Tons of Cooling from Existing Connected Units: This is the total existing tonnage of the water source heat pumps connected to the noted boiler(s).

12) Total Tons of Cooling from Proposed Connecting Units: This is the total proposed tonnage of the water source heat pumps connected to the noted boiler(s).

13) Existing HVAC Operating Schedule: This is the existing operating schedule of the HVAC units served by the boilers. Up to three different operating schedules can be made, and at least one schedule is required.

14) Number of Holidays: This is the number of days that adhere to the existing HVAC holiday schedule.

15) Electric Utility Incentive: This is the electric utility incentive for the boiler retrofit measure. It must be input in dollars [$]: i.e. [$/kWh], [$/megaBTU], or [$/Boiler].

16) Gas Utility Incentive: This is the gas utility incentive for the boiler retrofit measure. It must be input in dollars [$]: i.e. [$/therm], [$/megaBTU], or [$/Boiler].

17) Total Measure Cost: This is the estimated cost of a boiler retrofit measure. The CEAT automatically populates this field however, this number can be changed if needed.

Once you are finished entering the user inputs on the WSHP Boiler Retrofit tab, press the “Save and Add” button followed by the “Save and Continue” button and the information entered for the unit will be added to the top of the tab (above the input fields) and you can begin entering information for the next unit (see FIG. 31). When you are finished entering units, press the “Save and Continue” button and you will be taken to the WSHP CT VFD tab.

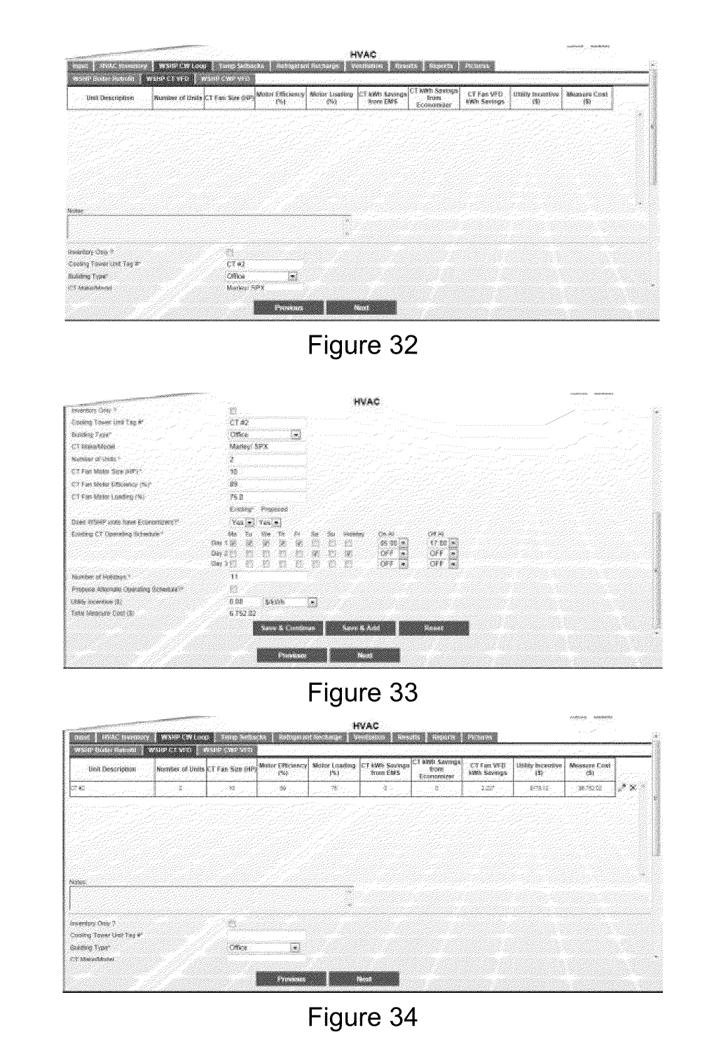

The inputs for the WSHP CT VFD tab are as follows (See FIGS. 32-33):

1) Inventory Only?: Check this box if you are not recommending any of the above measures, and the equipment only needs to be entered into the building's Cooling Tower inventory.

2) Cooling Tower Unit Tag #: This is the customer's number or designation for the cooling tower.

3) Building Type: This is the type of building that the water source heat pumps are serving.

4) CT Make/Model: This is the manufacturer and model number of the cooling tower.

5) Number of Units: This is the number of units that all have the same inputs.

6) CT Fan Motor Size: This is the size of the fan motor for the cooling tower and must be entered in horsepower (HP).

7) CT Fan Motor Efficiency: This is the efficiency of the fan motor on the cooling tower.

8) CT Fan Motor Loading: This is the fan motor loading percentage. This input is automatically set to 75%, but it can be changed if needed.

9) Does Fan Motor Have VFD?

10) Do Existing WSHP Units Have Economizers?

11) Do Proposed WSHP Units Have Economizers?

12) Existing CT Operating Schedule: Up to three different operating schedules can be made and at least one schedule is required.

13) Number of Holidays: This is the number of days that adhere to the existing cooling tower holiday schedule.

14) Propose Alternate Operating Schedule: Check this box if a new operating schedule is proposed or if a different type of schedule control is proposed. If this box is checked, proposed operating schedule inputs will appear on the screen.

15) Proposed Type of Schedule Control

16) Proposed HVAC Operating Schedule: Up to three different operating schedules can be made and at least one schedule is required.

17) Proposed Number of Holidays: This is the number of days that adhere to the proposed cooling tower holiday schedule.

18) Utility Incentive: This is the utility incentive for a WSHP cooling tower fan motor VFD installation measure. It must be input in dollars [$]: i.e. [$/kWh] or [$/HP].

19) Total Measure Cost: This is the estimated cost of a WSHP cooling tower fan motor VFD installation measure. The CEAT automatically populates this field; but this number can be changed if needed.

Once you are finished entering the user inputs on the WSHP CT VFD tab, press the “Save and Add” button followed by the “Save and Continue” button and the information entered for the unit will be added to the top of the tab (above the input fields) and you can begin entering information for a new unit (see FIG. 34). When you are finished entering information for all units, press the “Save and Continue” button and you will be taken to the WSHP CWP VFD tab.

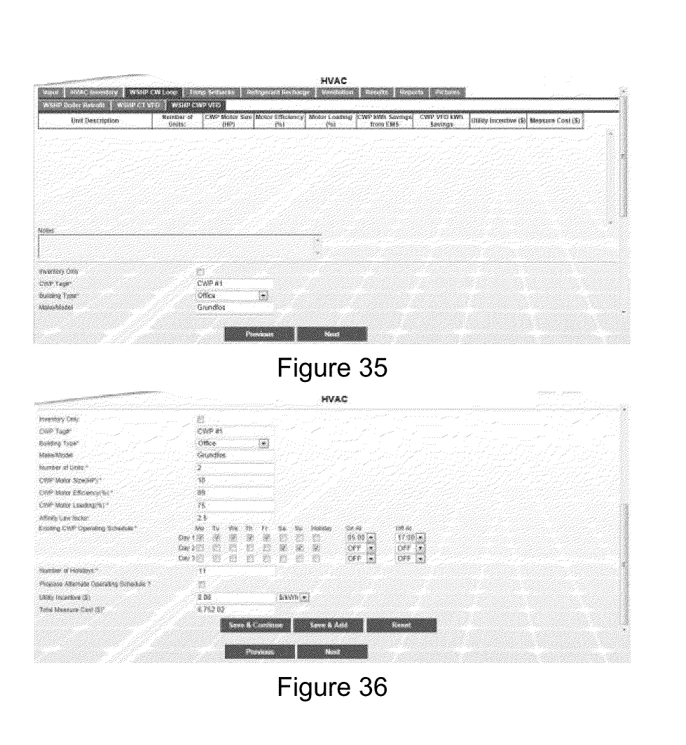

The inputs for the WSHP CWP VFD tab are as follows (See FIGS. 35-36):

1) Inventory Only: Check this box if you are not recommending any of the measures, and the equipment only needs to be entered into the building's Cooling Tower inventory.

2) CWP Tag #: This is the customer's number or designation for the cooling tower.

3) Building Type

4) Make/Model

5) Number of Units: This is the number of units that all have the same inputs.

6) CWP Motor Size: This is the size of the pump motor for the condenser water and must be entered in horsepower (HP).

7) CWP Motor Efficiency: This is the efficiency of the pump motor on the condenser water.

8) CWP Motor Loading: This is the pump motor loading percentage. This input is automatically set to 75%, but it can be changed if needed.

9) Affinity Law Factor: This is the affinity law factor for the CW Pumps. It is automatically set to 2.5, but this may be changed if needed.

10) Does Pump Motor has VFD?

11) Existing CWP Operating Schedule: Up to three different operating schedules can be made and at least one schedule is required.

12) Number of Holidays: This is the number of days that adhere to the existing condenser water pump holiday schedule.

13) Propose Alternate Operating Schedule: Check this box if a new operating schedule is proposed or if a different type of schedule control is proposed. If this box is checked, proposed operating schedule inputs will appear on the screen.

14) Proposed Type of Schedule Control

15) Proposed CWP Operating Schedule: Up to three different operating schedules can be made and at least one schedule is required.

16) Proposed Number of Holidays: This is the number of days that adhere to the proposed condenser water pump holiday schedule.

17) Utility Incentive: This is the utility incentive for a WSHP condenser water pump motor VFD installation measure. It must be input in dollars [$]: i.e. [$/kWh] or [$/HP].

18) Total Measure Cost: This is the estimated cost of a WSHP condenser water pump motor VFD installation measure. The CEAT automatically populates this field, but this number can be changed if needed.

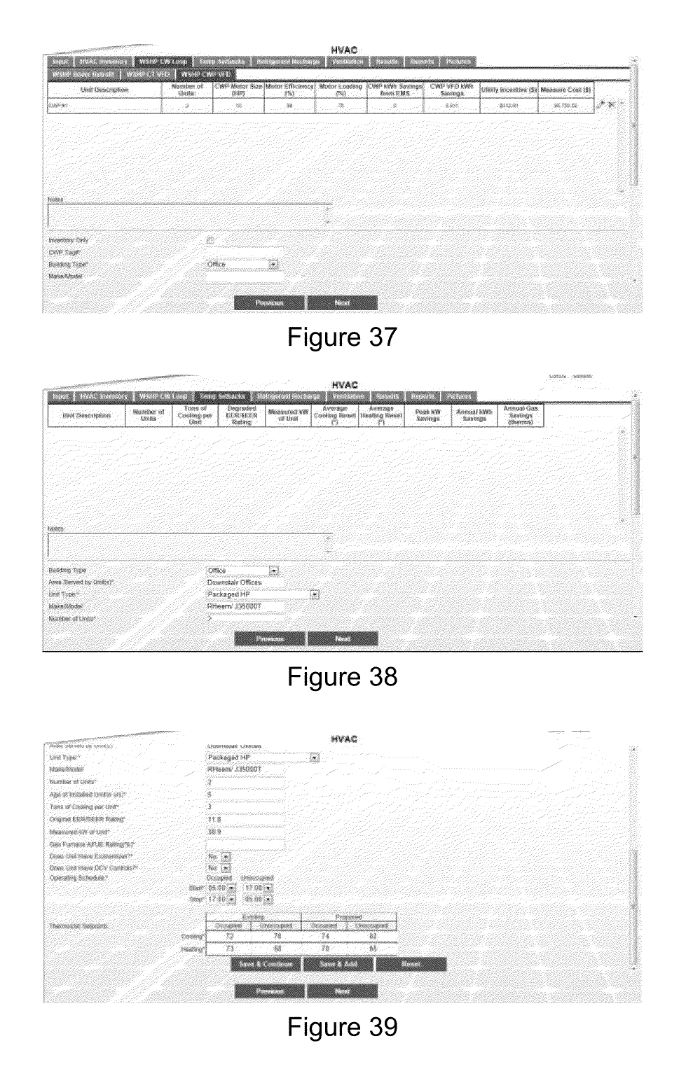

Once you are finished entering the user inputs on the WSHP CWP VFD tab, press the “Save and Add” button followed by the “Save and Continue” button and the information entered for the unit will be added to the top of the tab (above the input fields) and you can begin entering information for a new unit (see FIG. 37). When you are finished entering information for all units, press the “Save and Continue” button and you will be taken to the Temp Setbacks tab.

Temp Setbacks Tab

The inputs for the Temp Setbacks tab are used to calculate savings from temperature setbacks during heating periods, cooling periods, or both. The inputs for this tab are as follows (See FIGS. 38-39):

1) Building Type:

2) Area Served by Unit(s)

3) Unit Type

4) Make/Model

5) Number of Units: This is the number of units that all have the same information on the Input tab.

6) Age of Installed Unit: This is the age of the unit since it was installed regardless of its time of use.

7) Tons of Cooling per Unit

8) Original EER/SEER Rating: This is the original EER/SEER rating of the existing unit (the CEAT will automatically decrease the rating based on the age of the unit).

9) Measured kW of Existing Unit: This is the measured kW of the existing unit, if a measurement has been performed. If a kW reading is entered, the CEAT will use this number within the calculations, instead of the degraded existing original EER/SEER rating.

10) Existing Gas Furnace AFUE Rating: This is the AFUE rating of the gas furnace on the existing unit. This input only appears on the input tab if “Packaged HP w/Gas Furnace” or “Split System AC w/Gas Furnace” is selected in the “Unit Type” drop down menu.

11) Does Existing Unit Have Economizer:

12) Does Existing Unit Have DCV Controls:

13) Operating Schedule: This is the operating schedule for the occupancy of the building. You must enter the start and stop times for when the building is both occupied and unoccupied.

14) Thermostat Setpoints: These are the existing and proposed thermostat setpoints for the heating/cooling states and occupied/unoccupied times for the building.

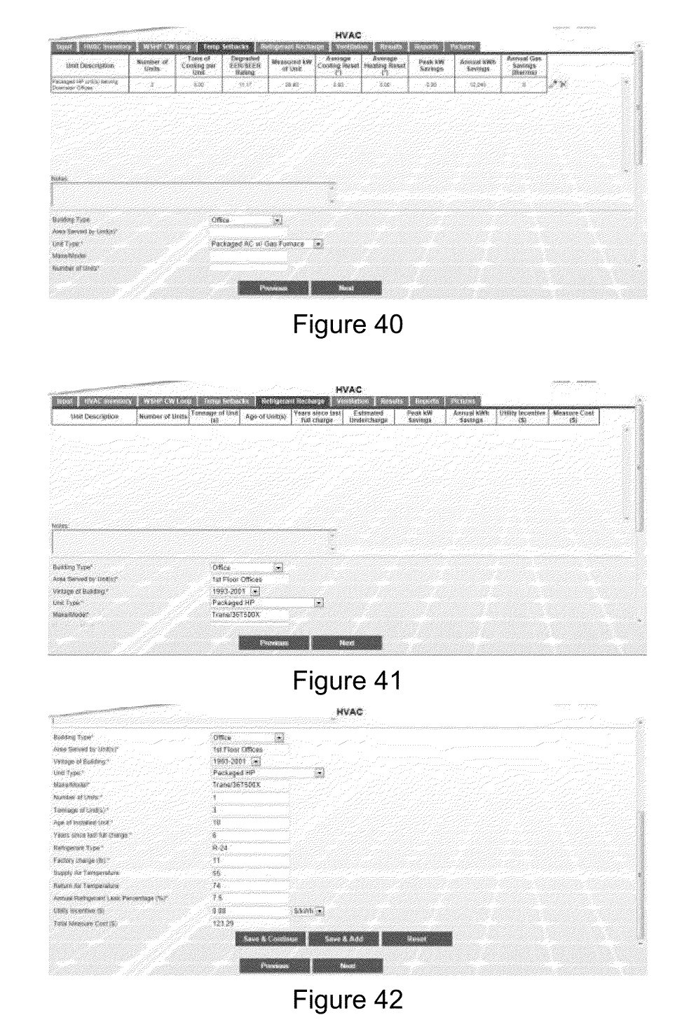

Once you are finished entering the user inputs on the Temp Setbacks tab, press the “Save and Add” button followed by the “Save and Continue” button and the information entered for the unit will be added to the top of the tab (above the input fields) and you can begin entering information for a new unit (see FIG. 40).

When you are finished entering information for all units, press the “Save and Continue” button and you will be taken to the Refrigerant Recharge tab.

Refrigerant Recharge Tab

The inputs for the Refrigerant Recharge tab are used to calculate savings from a refrigerant recharge on package HVAC units. The inputs are as follows (See FIGS. 41-42):

1) Building Type

2) Area Served by Unit(s)

3) Vintage of Building: This is the year the building was built. You may not enter a specific year; instead you must choose a range of years from the drop down menu.

4) Unit Type

5) Make/Model

6) Number of Units: This is the number of units that all have the same information on the Input tab.

7) Age of Installed Unit(s)?: This is the age of the unit since it was installed, regardless of its time of use.

8) Years Since Last Full Charge

9) Refrigerant Type

10) Factory Charge: This is the amount of original refrigerant that was charged in the unit and must be entered in pounds (lbs.)

11) Supply Air Temperature: This is the temperature of the air supplied to the building by the unit.

12) Return Air Temperature: This is the temperature of the air that is returned to the unit from the building.

13) Annual Refrigerant Leak Percentage: This is the approximate percentage of refrigerant that leaks from the unit each year. It is automatically set to 7.5%, but this value can be changed if needed.

14) Utility Incentive: This is the utility incentive for a refrigerant recharge measure. It must be input in dollars [$]: i.e. [$/kWh].

15) Total Measure Cost: This is the estimated cost of a refrigerant recharge measure. The CEAT automatically populates this field, but this number can be changed if needed.

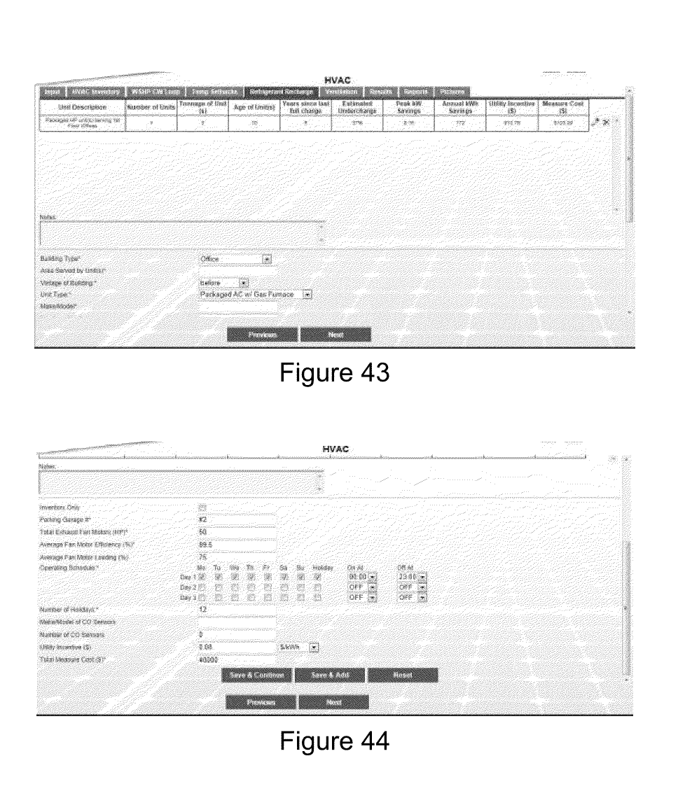

Once you are finished entering the user inputs on the Refrigerant Recharge tab, press the “Save and Add” button followed by the “Save and Continue” button and the information entered for the unit will be added to the top of the tab (above the input fields) and you can begin entering information for a new unit (see FIG. 43).

When you are finished entering units, press the “Save and Continue” button and you will be taken to the Ventilation tab.

Ventilation Tab

There are two sub-tabs under the Ventilation tab:

A. CO Sensors on Pkg (Parking) Garages: The inputs for this tab are used to calculate savings when Carbon Monoxide (CO) sensors are installed on underground parking garage exhaust fans.

B. VFD on Kitchen Exhaust: The inputs for this tab are used to calculate savings when variable frequency drives (VFDs) are installed on kitchen exhaust fans.

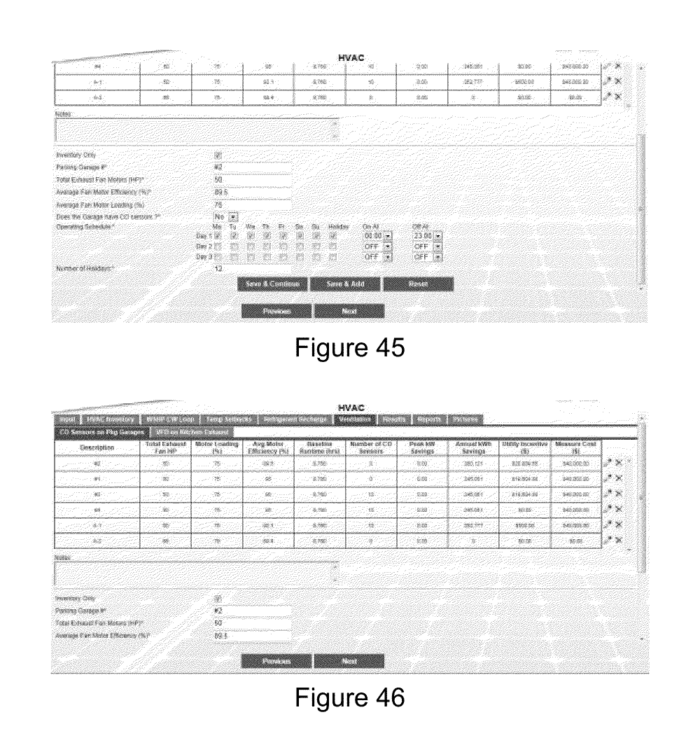

The inputs for the CO Sensors on Pkg Garages tab are as follows (See FIG. 44-45):

1) Inventory Only: Check this box if you are not recommending the measure, and the equipment only needs to be entered into the parking garage exhaust fan inventory.

2) Parking Garage #: This is the designation of the parking garage where the exhaust fan is located (and does not have to be a number).

3) Total Exhaust Fan Motors (HP): This is the total motor horsepower of all exhaust fans in the parking garage.

4) Average Fan Motor Efficiency: This is the average fan motor efficiency of all exhaust fans in the parking garage.

5) Average Fan Motor Loading: This is the average fan motor loading of all exhaust fans in the parking garage. This input is automatically set to 75.0%, but this can be changed if needed.

6) Does the Garage Have CO Sensors: This input only appears if the “Inventory Only” box is checked.

7) Operating Schedule: Up to three different operating schedules can be made and at least one schedule is required.

8) Number of Holidays: This is the number of days that adhere to the existing parking garage fan holiday schedule

9) Make/Model of CO Sensors: This is the manufacturer and model number of the proposed Carbon Monoxide sensor.

10) Number of Sensors: This is the proposed number of sensors to be installed for the parking garage fans or the number of existing sensors if preparing inventory.

11) Utility Incentive: This is the utility incentive for Carbon Monoxide sensor installation measure. It must be input in dollars [$]: i.e. [$/kWh], [$/Sensor], or [$/HP].

12) Total Measure Cost: This is the estimated cost of a Carbon Monoxide sensor installation measure. The CEAT automatically populates this field, but this number can be changed if needed.

Once you are finished entering the user inputs on the CO Sensors on Pkg Garages tab, press the “Save and Add” button followed by the “Save and Continue” button and the information entered for the unit will be added to the top of the tab (above the input fields) and you can begin entering information for a new unit (see FIG. 46).

When you are finished entering units, press the “Save and Continue” button and you will be taken to the VFD on Kitchen Exhaust tab.

VFD on Kitchen Exhaust

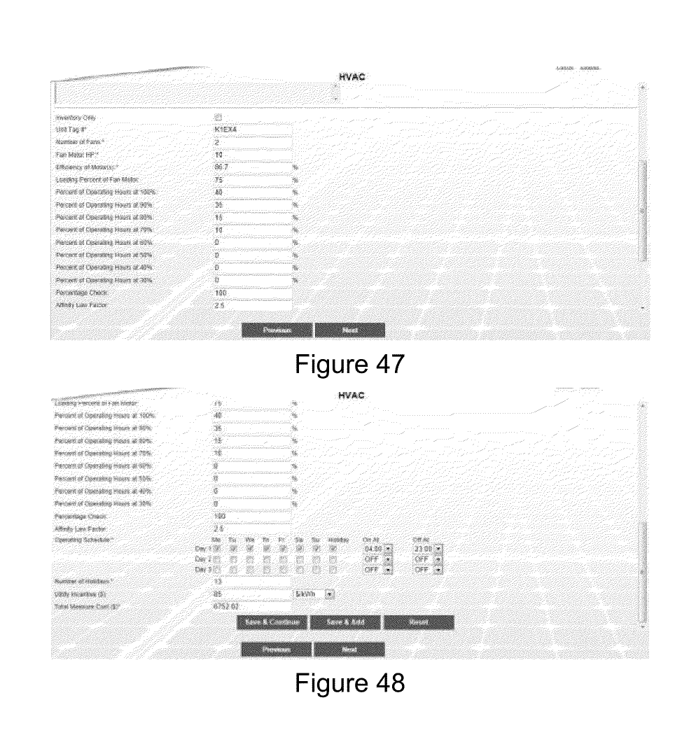

The inputs for the VFD on Kitchen Exhaust tab are as follows (See FIGS. 47-48):

1) Inventory Only: Check this box if you are not recommending the measure, and the equipment only needs to be entered into the parking garage exhaust fan inventory.

2) Unit Tag #

3) Number of Fans

4) Fan Motor HP: If there are more than one fan on the unit with different horsepowers, multiple lines can be entered.

5) Efficiency of Motors: If there are more than one fan on the unit with different efficiencies, multiple lines can be entered.

6) Loading Percent of Pump Motor: This is the average fan motor loading of all exhaust fans in the kitchen. This input is automatically set to 75.0%, but this can be changed if needed.

7) Does the Kitchen Exh Fans have VFDs

8) Percent of Loading Hours at 100%: This percentage is your estimation as the auditor. It is automatically set to 30%, but this may be changed if needed.

9) Percent of Loading Hours at 90%: This is the percentage of time that the exhaust fan(s) will run at 90% of their full speed if a VFD is installed. This percentage is your estimation as the auditor. It is automatically set to 25%, but this may be changed if needed.

10) Percent of Loading Hours at 80%: This is the percentage of time that the exhaust fan(s) will run at 80% of their full speed if a VFD is installed. This percentage is your estimation as the auditor. It is automatically set to 15%, but this may be changed if needed.

11) Percent of Loading Hours at 70%: This is the percentage of time that the exhaust fan(s) will run at 70% of their full speed if a VFD is installed. This percentage is your estimation as the auditor. It is automatically set to 10%, but this may be changed if needed.

12) Percent of Loading Hours at 60%: This is the percentage of time that the exhaust fan(s) will run at 60% of their full speed if a VFD is installed. This percentage is your estimation as the auditor. It is automatically set to 10%, but this may be changed if needed.

13) Percent of Loading Hours at 50%: This is the percentage of time that the exhaust fan(s) will run at 50% of their full speed if a VFD is installed. This percentage is your estimation as the auditor. It is automatically set to 5%, but this may be changed if needed.

14) Percent of Loading Hours at 40%: This is the percentage of time that the exhaust fan(s) will run at 40% of their full speed if a VFD is installed. This percentage is your estimation as the auditor. It is automatically set to 5%, but this may be changed if needed.

15) Percent of Loading Hours at 30%: This is the percentage of time that the exhaust fan(s) will run at 30% of their full speed if a VFD is installed. This percentage is your estimation as the auditor. It is automatically set to 0%, but this may be changed if needed.

16) Percentage Check: This input is the addition of all of the percentages of operating hours from 100% to 30% and should add up to 100%.

17) Affinity Law Factor: This is the affinity law factor for the exhaust fans. It is automatically set to 2.5, but this may be changed if needed.

18) Operating Schedule: Up to three different operating schedules can be made and at least one schedule is required.

19) Number of Holidays: This is the number of days that adhere to the existing exhaust fan holiday schedule.

20) Utility Incentive: This is the utility incentive for VFD installation on exhaust fans. It must be input in dollars [$]: i.e. [$/kWh], [$/Sensor], or [$/HP].

21) Total Measure Cost: This is the estimated cost of a VFD on exhaust fans installation measure. The CEAT automatically populates this field, but this number can be changed if needed.

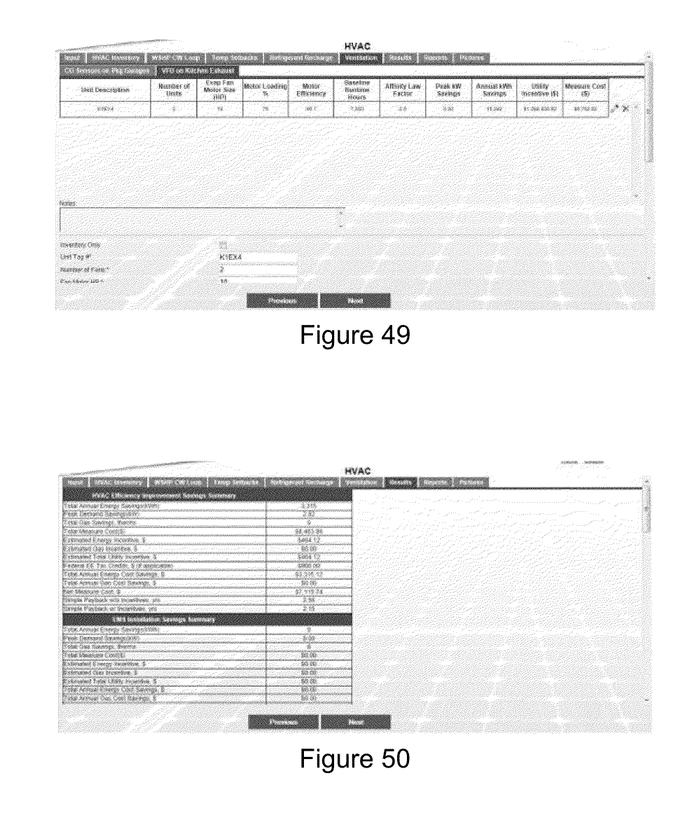

Once you are finished entering the user inputs on the VFD on Kitchen Exhaust tab, press the “Save and Add” button followed by the “Save and Continue” Button and the information entered for the unit will be added to the top of the tab (above the input fields) and you can begin entering information for a new unit (see FIG. 49).

When you are finished entering units, press the “Save and Continue” button and you will be taken to the Results tab.

C. Results

The Results tab contains important calculated information for the different measures. Each measure tab has a section in the Results tab. If a certain measure tab has been left blank, then its corresponding results section will show zeros for all fields. The list of calculation information displayed on the Results tab is listed below. Please note two important items:
All information is not applicable to all measures. In cases where calculated information is not applicable, the result field for this information will either be “0” or that field will not exist under the measure-specific section.
The result fields for each measure are for that measure ONLY.

1) Total Annual Energy Savings [kWh]

2) Peak Demand Savings [kW]

3) Total Gas Savings [Therms]

4) Total Measure Cost [$]

5) Estimated Energy Incentive [$]: This is the incentive for energy (kWh) savings only.

6) Estimated Gas Incentive [$]: This is the incentive for gas savings only.

7) Estimated Total Utility Incentive [$]: This is the combination of energy and gas savings incentives. This will be limited to 50% of the total measure cost.

8) Federal EE Tax Credits [$]: This is only applicable in certain HVAC efficiency improvement measures.

9) Total Annual Energy Cost Savings [$]: This is the energy (kWh) cost savings only.

10) Total Annual Gas Cost Savings [$]: This is the gas cost savings only.

11) Net Measure Cost [$]

12) Payback with Incentive [Years]

13) Payback without Incentive [Years]

D. Reports

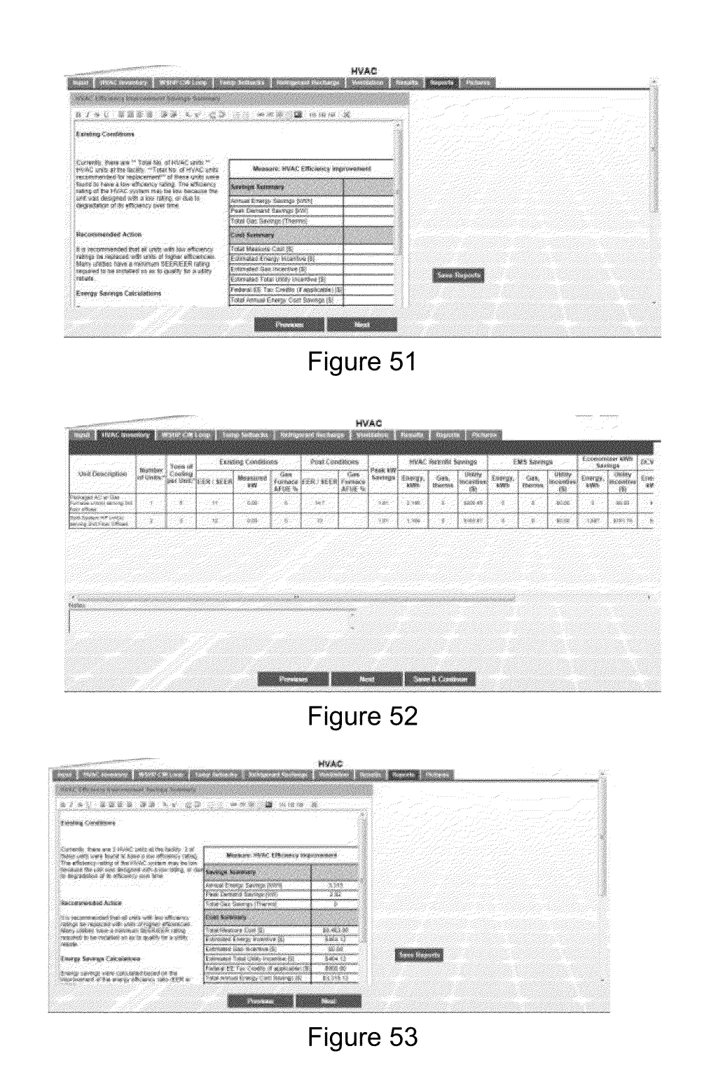

The Reports tab generates boiler plate reports for each measure and inserts the results information into a table within the report (See FIG. 50). The report for each section will be initially blank (See FIG. 51). To populate it, open the report you wish to work on and press the “Save and Continue” button on the corresponding EEM inventory page (See FIG. 52). This will populate the results table and certain text fields within the report. This report can be manipulated and saved. Press “Save Reports” to populate the final report with the measures proposed (See FIG. 53).

E. Pictures

The Pictures tab allows you to insert pictures taken during the audit into the file. These pictures will be populated within the audit report. The CEAT is limited to 10 pictures per module, and 15 pictures overall in some embodiments, and in other embodiments, there is no limit to pictures.

### Water Heating Module

The Water Heating Module covers the retrofit of different types of domestic hot water heating systems and equipment. The calculations take into account baseline energy usage and proposed energy usage, which is based on the estimated water consumption of fixtures connected to the domestic hot water heating systems (input by the user).

A Domestic Hot Water Heating Retrofit EEM is the retrofit/upgrade of any domestic hot water heating equipment for the building. A Domestic Hot Water Temperature Reset EEM is the lowering of hot water temperatures to result in less energy usage without impacting the building users. A Domestic Hot Water Blanket Installation EEM is the installation of a blanket on tank water heaters to add insulation and ultimately reduce losses and energy consumption of the unit.

One particular example of a water heating module may include:

A. Energy Efficiency Measures (EEMs) Covered

The Water Heating Module covers the retrofit of different types of domestic hot water heating systems and equipment. The calculations take into account baseline energy usage and proposed energy usage, which is based on the estimated water consumption of fixtures connected to the domestic hot water heating systems (input by the user).

Domestic Hot Water Heating Retrofit

This EEM is the retrofit/upgrade of any domestic hot water heating equipment for the building.

Domestic Hot Water Temperature Reset

This EEM is the lowering of hot water temperatures to result in less energy usage without impacting the building users.

Domestic Hot Water Blanket Installation

This EEM is the installation of a blanket on tank water heaters to add insulation and ultimately reduce losses and energy consumption of the unit.

B. User Inputs

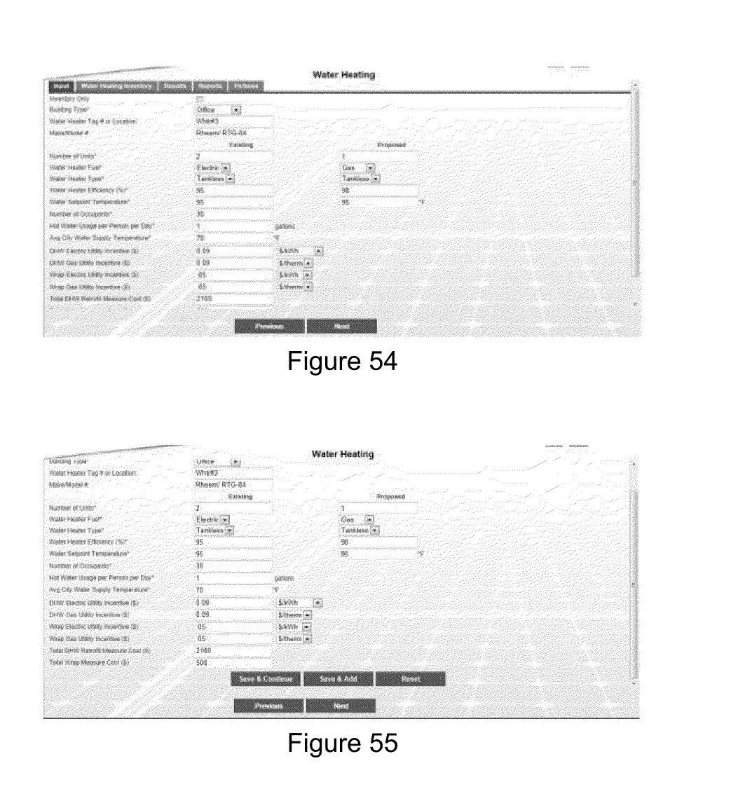

These are the inputs the user needs to give the CEAT so it can calculate savings and incentive numbers. User Inputs are found on the Inputs tab. Please see FIG. 54 for reference.

C. User Input List

The following entries are required on the Inputs tab.

1) Inventory Only: Check this box if you are not interested in calculating energy savings for this piece of equipment and you only need the information for inventory purposes (See FIG. 55). When checked, all proposed fields will be disabled.

2) Building Type: Select whether the building is classified as an office, restaurant, or retail.

3) Water Heater Tag # or Location: This is for your reference if there are multiple water heating units in a building.

4) Make/Model #

5) Numbers of Units: How many units (of the exact same make and model) are there? (Enter information for both existing and proposed units.)

6) Water Heater Fuel: Electric or Gas?: Enter information for both existing and proposed units.

7) Water Heater Type: Tank or Tankless: Enter information for both existing and proposed units.

8) Water Heater Efficiency (%): Enter the efficiency of the equipment for both existing and proposed units. This field is automatically populated based on the fuel type and water heater type selected, but the information can be changed if needed.

9) Water Setpoint Temperature: Enter the water setpoint temperature of the equipment for both Existing and Proposed units.

10) Number of Occupants: Enter the number of occupants that have access to the fixtures attached to the noted water heaters. The number of occupants is used to determine the annual hot water usage.

11) Hot Water Usage per Person per Day: Enter the number of gallons of hot water one person is expected to use each day. This field is automatically populated based on the building type selected, but the information can be changed if needed.

12) Average City Water Supply Temperature: Enter the average temperature from the water supplied by the city.

13) Average Ambient Temperature: Enter the average ambient temperature of the location of the water heater. (This input is not applicable for tankless water heaters.)

14) Gallons per Tank: How many gallons does this piece of equipment hold? (This input is not applicable for tankless water heaters.)

15) Add Water Heater Blanket: For existing units, does the water heater currently have an external insulating with a water heating blanket? For proposed units, would you like to add an external insulating with a water heating blanket? (This input does not apply if a tankless water heater is selected, and applies to both existing and proposed equipment.)

16) DHW Electric Utility Incentive: Enter the local utility's electric incentive rate in $/kWh, $/Tank, or $/Tankless.

17) DHW Gas Utility Incentive: Enter the local utility's gas incentive rate in $/therm.

18) Wrap Electric Utility Incentive: If the local electric utility company has an incentive for adding water heater blankets, enter it here in $/kWh or $/Wrap.

19) Wrap Gas Utility Incentive: If the local gas utility company has an incentive for adding water heater blankets, enter it here in $/kWh.

20) Total DHW Retrofit Measure Cost: This value is automatically estimated and populated based on previously input information, but can be changed if needed.

21) Total Wrap Measure Cost: This value is automatically estimated and populated based on input information about adding water heater blankets, but can be changed if needed.

D. Water Heating Inventory

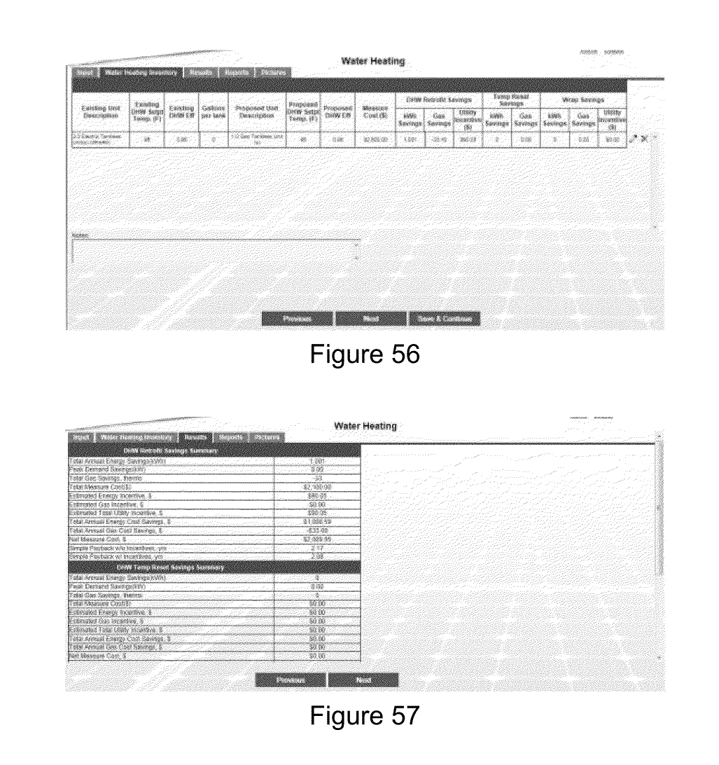

The Water Heating Inventory tab contains all the entered data for the domestic hot water units along with the calculated incentives for each proposed EEM (retrofit, temperature reset, and wrap incentives). Once you have completed entering data for the domestic hot water heating equipment, select the “Save and Add” button at the bottom of the Inputs tab. This tab will be blank unless “Save and Continue” is pressed once information has been entered (see FIG. 56).

E. Results

The Water Heating Results tab contains the calculated incentives for each proposed EEM (retrofit, temperature reset, and wrap incentives). These fields will automatically calculate and populate once the Water Heating Inventory tab is completed (see FIG. 57).

F. Report

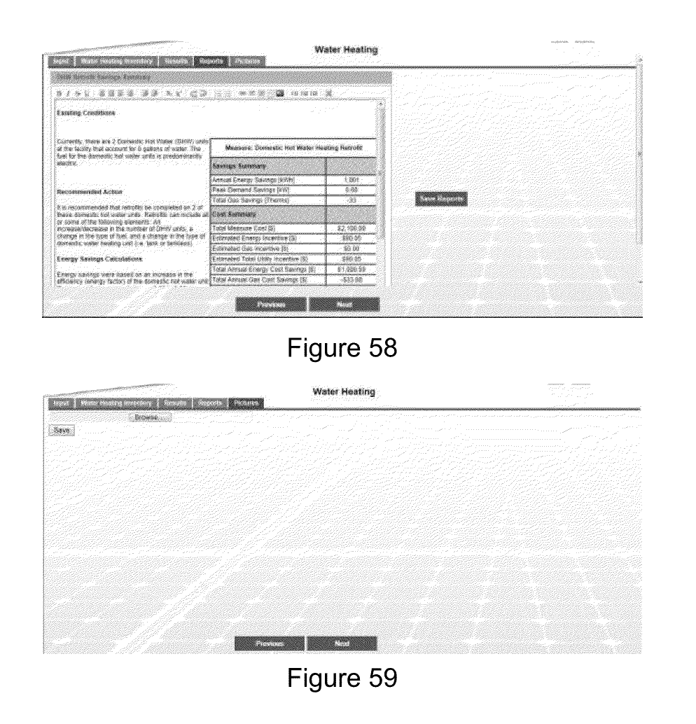

The Report tab generates a boiler plate report and inserts the results information into a table (see FIG. 58). This report can be manipulated and saved.

G. Pictures

The Pictures Tab allows you to insert pictures taken during the audit into the file. These pictures can be used for audit reports later (see FIG. 59).

### Refrigeration Module

The Refrigeration Module covers the retrofit of different types refrigeration units like walk-in coolers, freezers, and ice makers. The calculations take into account baseline energy usage and proposed energy usage, which is based on one or more user inputs which include age of equipment, dimensions of doors, unit efficiency, etc.

An Auto Door Closers EEM is the retrofit/upgrade of walk-in coolers and freezers with auto door closers which prevent loss of cooling. Without these, doors of walk-in coolers and freezers will have to be manually closed which will be generally influenced by for human error and ergonomics. A Door Gasket EEM is the retrofit/upgrade of door gaskets in walk-in coolers and freezers which help prevent leakages in cooled spaces. A High Efficiency (HE) Ice Maker EEM is the upgrade of ice makers with high efficiency units which use less energy and potable water to produce ice. Both energy and water can be saved when using these HE devices. A Strip Curtains EEM is the retrofit/upgrade of strip curtains in walk-in coolers and freezers which reduce cooling loss. This retrofit is more apt for walk-in coolers and freezers which are frequently accessed.

With regard to VFD on Evaporator (Evap) Fans, it is understood that Walk-in coolers and freezers are equipped with evaporator fans to distribute the cooling within spaces. These fans run at normal speed at all times, even if the thermostat is not calling for a cooling cycle. A variable frequency drive (VFD) allows the fans to run at slower speeds when the set point temperatures are attained.

One particular example of a Refrigeration Module may include:

A. Energy Efficiency Measures (EEMs) Covered

The Refrigeration Module covers the retrofit of different types refrigeration units like walk-in coolers, freezers, and ice makers. The calculations take into account baseline energy usage and proposed energy usage, which is based on one or more user inputs which include age of equipment, dimensions of doors, unit efficiency, etc.

Auto Door Closers

This EEM is the retrofit/upgrade of walk-in coolers and freezers with auto door closers which prevent loss of cooling. Without these, doors of walk-in coolers and freezers will have to be manually closed which will be generally influenced by for human error and ergonomics.

Door Gasket

This EEM is the retrofit/upgrade of door gaskets in walk-in coolers and freezers which help prevent leakages in cooled spaces.

High Efficiency (HE) Ice Maker

This EEM is the upgrade of ice makers with high efficiency units which use less energy and potable water to produce ice. Both energy and water can be saved when using these HE devices.

Strip Curtains

This EEM is the retrofit/upgrade of strip curtains in walk-in coolers and freezers which reduce cooling loss. This retrofit is more apt for walk-in coolers and freezers which are frequently accessed.

VFD on Evaporator (Evap) Fans

Walk-in coolers and freezers are equipped with evaporator fans to distribute the cooling within spaces. These fans run at normal speed at all times, even if the thermostat is not calling for a cooling cycle. A variable frequency drive (VFD) allows the fans to run at slower speeds when the set point temperatures are attained.

B. User Inputs

User inputs are found on the Auto Door Closers, Door Gasket EEM, HE Ice Maker, Strip Curtains and VFD on Evap Fans Tabs. The CEAT also uses inputs from the Utility Info, so it is imperative that this tab is filled out as well.

Auto Door Closers

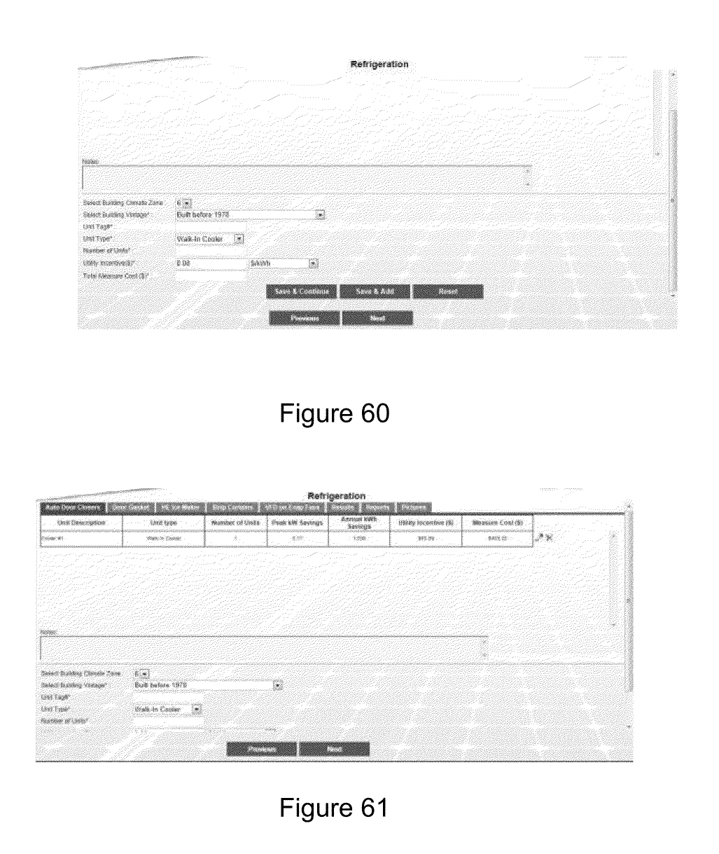

The inputs for this tab are used for calculating energy savings by having auto door closers in walk-in coolers and freezers. FIG. 60 shows the inputs for in this tab. The description of the inputs are as follows:

1) Select Building Climate Zone: Choose the climate zone in which the project is located from the 16 climate zones identified by California Energy Commission.

2) Select Building Vintage: Choose the year in which the building was built/retrofitted from the six categories offered.

3) Unit Tag#

4) Unit Type

5) Number of Units

6) Utility Incentive ($): This is the utility incentive for an auto door closer. The CEAT automatically sources this from Utility Info tab, but the user can override this if the incentives are specific to this measure. The amount must be input in dollars [$]: i.e. [$/kWh] or [$/closer].

7) Total Measure Cost ($): This is the estimated cost of auto door closer. The CEAT automatically populates this field, but this number can be changed if needed.

Once you are finished entering the user inputs on the Auto Door Closers tab, press the “Save and Add” button followed by the “Save and Continue” button and the information entered for the unit will be added to the top of the tab (above the input fields) and you can begin entering information for a new unit.

When you are done entering units, press the “Save and Continue” button and you will be taken to the Door Gasket EEM tab.

Door Gasket EEM

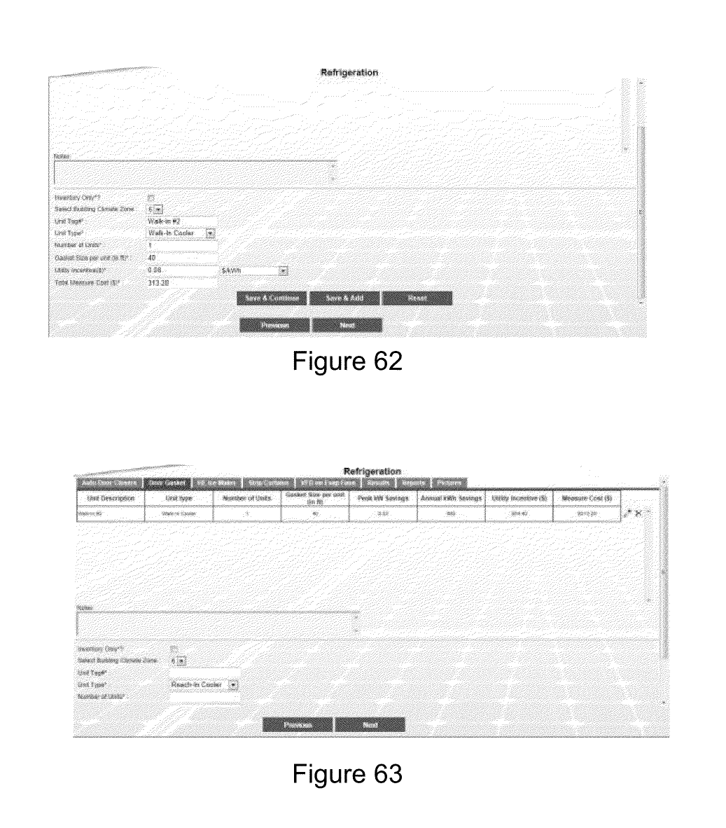

The inputs in the Door Gasket EEM tab are used for calculating energy savings by retrofitting Door Gasket. FIG. 62 shows the inputs for this tab. The description of the inputs are as below.

1) Inventory Only: Check this box if you are not recommending any of the above measures, and the equipment only needs to be entered into the building's inventory (See FIG. 63).

2) Select Building Climate Zone: Choose the climate zone in which the project is located from the 16 climate zones identified by California Energy Commission.

3) Unit Tag#

4) Unit Type

5) Number of Units

6) Gasket Size per unit (in ft)*: Input the size of the gasket in foot. This is approximately equal to the circumference of the door opening.

7) Utility Incentive ($): This is the utility incentive for a door gasket. The CEAT automatically sources this from Utility Info tab, but the user can override this if the incentives are specific to this measure. It must be input in dollars [$]: i.e. [$/kWh] or [$/ft] or [$/unit].

8) Total Measure Cost ($): This is the estimated cost of door gasket. The CEAT automatically populates this field, but this number can be changed if needed.

Once you are finished entering the user inputs on the Door Gasket tab, press the “Save and Add” button followed by the “Save and Continue” button and the information entered for the unit will be added to the top of the tab (above the input fields) and you can begin entering information for a new unit.

When you are done entering information for all units, press the “Save and Continue” button and you will be taken to the HE Ice maker tab.

HE Ice Maker

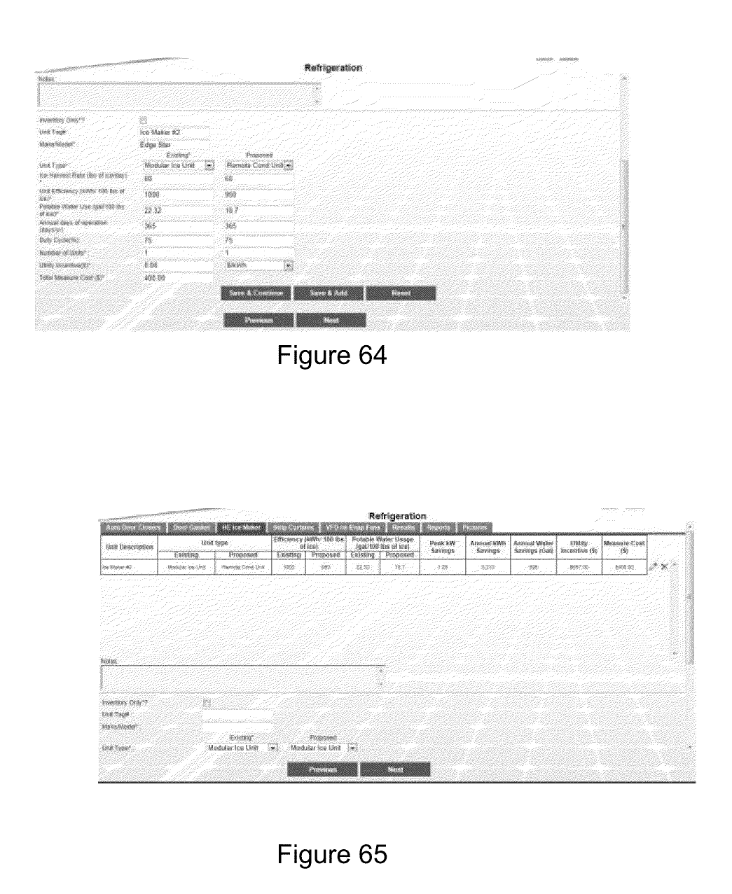

The inputs for the HE Ice Maker tab are used for calculating energy savings by upgrading standard ice makers to high-efficiency ice makers. FIG. 64 shows the inputs for this tab and the description of the inputs are as follows:

1) Inventory Only: Check this box if you are not recommending any of the above measures, and the equipment only needs to be entered into the building's inventory (See FIG. 65).

2) Unit Tag#

3) Make/Model: Input the Make/Model number which can be found of the name plate of the machine or manufacturer specifications/cut sheets.

4) Unit Type: This information can be found on the name plate of the machine or manufacturer specifications/cut sheets.

5) Ice Harvest Rate (lbs of ice/day): This is the capacity of the machine. Enter this value for both existing and proposed cases. This information can be found on the name plate of the machine or manufacturer specifications/cut sheets.

6) Unit Efficiency (kWh/100 lbs of ice): This is the efficiency of the machine. Enter this value for both existing and proposed cases. This information can be found on name plate of the machine or manufacturer specifications/cut sheets.

7) Potable Water Use (gal/100 lbs of ice): This is quantity of water consumed by these machines. Based on Ice Harvest Rate, the CEAT estimates this value; however, this can be overridden by user Input for both existing and proposed cases and information can be found on the manufacturer specifications/cut sheets.

8) Annual days of operation (days/yr): A default value of 365 days is considered by the CEAT. However, this can be overridden by user input for both existing and proposed cases based on the actual number of days these machines are operated per year.

9) Duty Cycle (%): This is the time the equipment spends in an active state as a fraction of the total time under consideration. A default of 75% is assumed by the CEAT. This can be overridden by user input for both existing and proposed cases.

10) Number of Units: Input the quantity of units for both existing and proposed cases.

11) Utility Incentive ($): This is the utility incentive for a high-efficiency ice maker. The CEAT automatically sources this from the Utility Info tab. However, the user can override this if the incentives are specific to this measure. Information must be input in dollars [$]: i.e. [$/kWh] or [$/unit].

12) Total Measure Cost ($): This is the estimated cost of HE Ice Maker. The CEAT automatically populates this field, but this number can be changed if needed.

Once you are finished entering the user inputs on the HE Ice Maker tab, press the “Save and Add” button followed by the “Save and Continue” button and the information entered for the unit will be added to the top of the tab (above the input fields) and you can begin entering information for a new unit.

When you are done entering information for all units, press the “Save and Continue” button and you will be taken to the Strip Curtains tab.

Strip Curtains

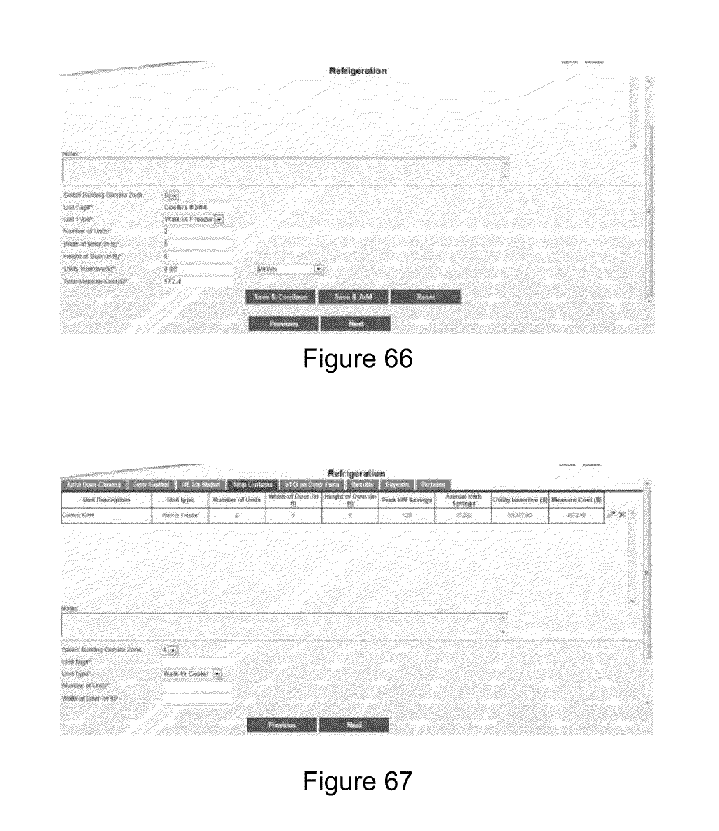

The inputs for the Strip Curtains tab are used for calculating energy savings by retrofit/upgrade of strip curtains in walk-in cooler and walk-in freezer. FIGS. 66-67 shows the inputs for in this tab. The description of the inputs is as follows:

1) Select Building Climate Zone: Choose the climate zone in which the project is located from the 16 climate zones identified by California Energy Commission.

2) Unit Tag#

3) Unit Type

4) Number of Units

5) Width of Door (in ft)*

6) Height of Door (in ft)*

7) Utility Incentive ($): This is the utility incentive for a strip curtain The CEAT automatically sources this from the Utility Info tab. However, the user can override this if the incentives are specific to this measure. Information must be input in dollars [$]: i.e. [$/kWh] or [$/sq.ft.] or [$/unit].

8) Total Measure Cost ($): This is the estimated cost of strip curtains. The CEAT automatically populates this field, but this number can be changed if needed.

Once you are finished entering the user inputs on the Strip Curtains tab, press the “Save and Add” button followed by the “Save and Continue” button and the information entered for the unit will be added to the top of the tab (above the input fields) and you can begin entering information for a new unit.

When you are done entering information for all units, press the “Save and Continue” button and you will be taken to the VFD on Evap Fans tab.

VFD on Evap Fans

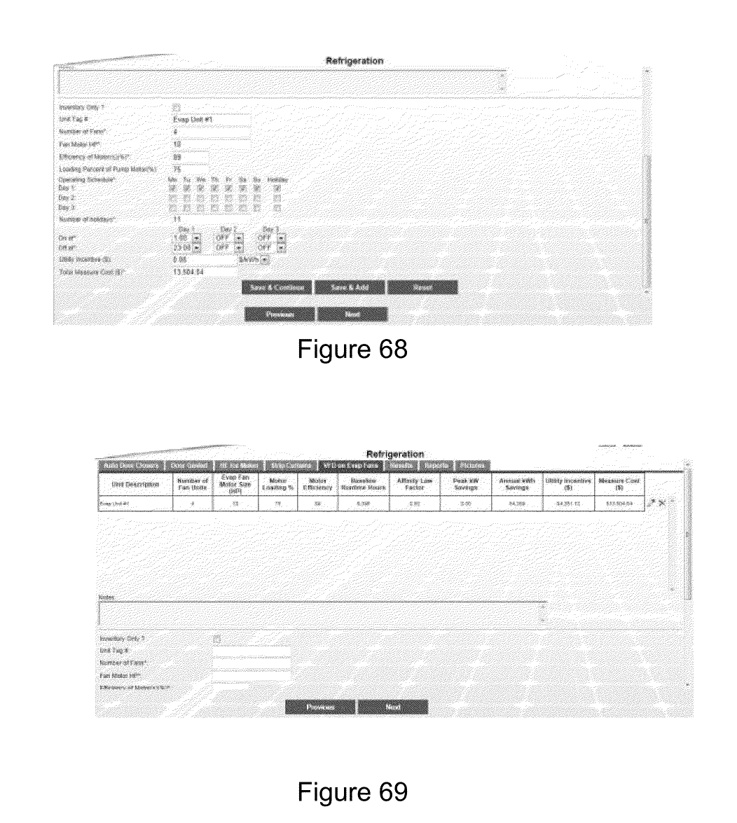

The inputs for the VFD on Evap Fans tab are used for calculating energy savings by having VFD on evaporator fans in walk-in coolers and walk-in freezers. FIG. 68 shows the inputs for in this tab and the description of the inputs are as follows:

1) Inventory Only: Check this box if you are not recommending the measure, and the equipment only needs to be entered into the evaporator fan's inventory (See FIG. 69).

2) Unit Tag #

3) Number of Fans

4) Fan Motor HP: If there are more than one fan on the unit with different horsepower, multiple lines can be entered.

5) Efficiency of Motors (%): This can be found on the motor name plate. If there are more than one fan on the unit with different efficiencies, multiple lines can be entered.

6) Loading Percent of Pump Motor (%): This is the average fan motor loading of all evaporator fans in an evaporator unit. This input is automatically set to 75.0%, but can be changed if needed.

7) Operating Schedule: This is the existing operating schedule of the evaporator fans. Up to three different daily operating schedules can be made and at least one schedule is required.

8) Number of Holidays: This is the number of holidays that adhere to the existing evaporator fan holiday schedule.

9) On at: Input the time at which the evaporator fan will be ON for the day types selected in operating schedule.

10) Off at: Input the time at which the evaporator fan will be OFF for the day types selected in operating schedule.

11) Utility Incentive: This is the utility incentive for VFD installation on evaporator fans. Information must be input in dollars [$]: [$/kWh], [$/Fan], or [$/HP].

12) Total Measure Cost: This is the estimated cost of a VFD on evaporator fans installation measure. The CEAT automatically populates this field, but this number can be changed if needed.

Once you are finished entering the user inputs on the VFD on Evap Fans tab, press the “Save and Add” button followed by the “Save and Continue” button and the information you entered for the unit will be added to the top of the tab (above the input fields) and you can begin entering information for a new unit.

When you are finished entering information for all units, press the “Save and Continue” button and you will be taken to the Results tab.

C. Results

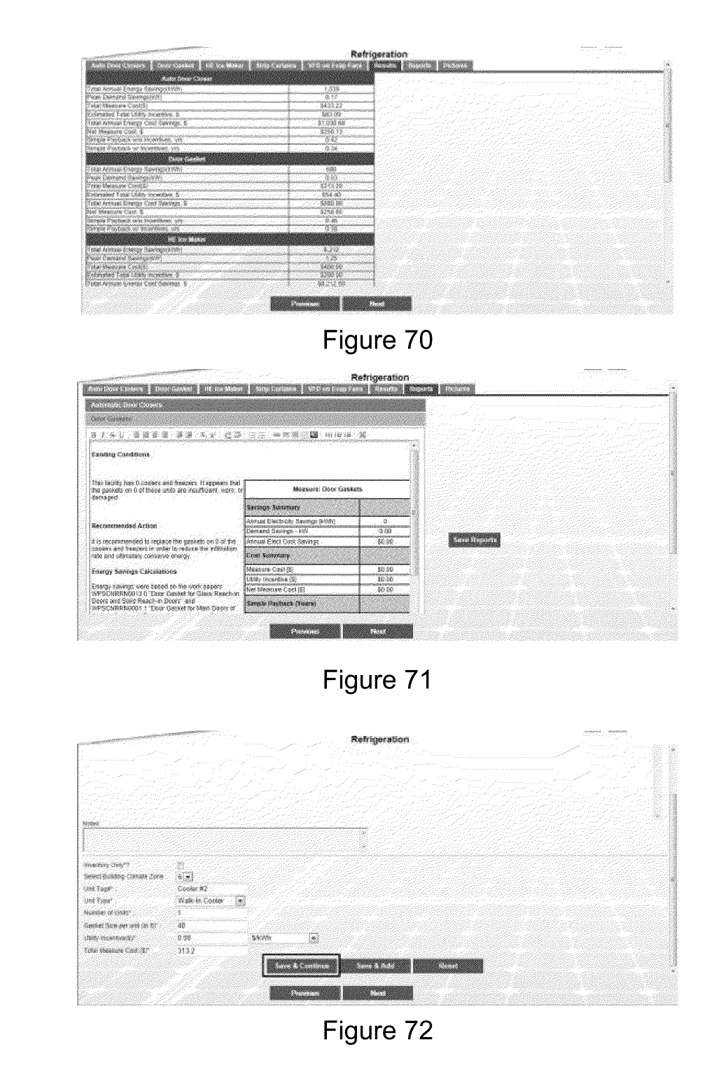

The Results tab contains important calculated information for the different measures. Each measure tab has a section in the Results tab (See FIG. 70). If a certain measure tab has been left blank, then its corresponding results section will show zeros for all fields. The list of calculation information displayed on the Results tab as listed below. Please note two important items:

A. All information is not applicable to all measures. In cases where calculated information is not applicable, the result field for this information will either be “0” or that field will not exist under the measure-specific section.

B. The result fields for each measure are for that measure ONLY.

1) Total Annual Energy Savings [kWh]

2) Peak Demand Savings [kW]

3) Total Gas Savings [Therms]

4) Total Measure Cost [$]

5) Estimated Energy Incentive [$]: This is the incentive for energy (kWh) savings only.

6) Estimated Gas Incentive [$]: This is the incentive for gas savings only.

7) Estimated Total Utility Incentive [$]: This is the combination of energy and gas savings incentives. This will be limited to 50% of the total measure cost.

8) Federal EE Tax Credits [$]: This is only applicable in certain HVAC efficiency improvement measures.

9) Total Annual Energy Cost Savings [$]: This is the energy (kWh) cost savings only.

10) Total Annual Gas Cost Savings [$]: This is the gas cost savings only.

11) Net Measure Cost [$]

12) Simple Payback w/o (without) Incentive [Years]

13) Simple Payback w/ (with) Incentive [Years]

D. Reports

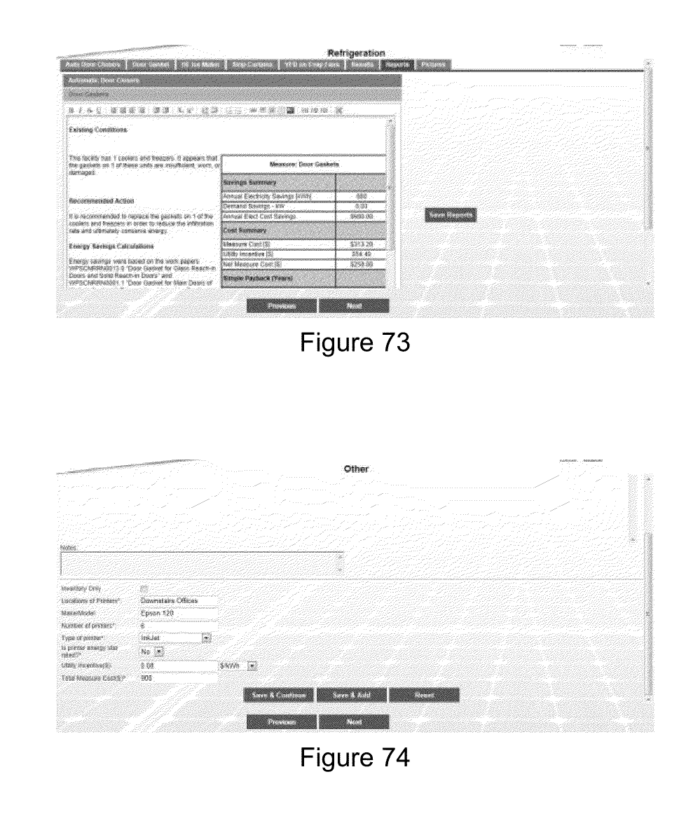

The Report tab generates reports for each Refrigeration measure and inserts the results information into a table in the report. The report for each section will be initially blank (See FIG. 72). To populate it, open the report you wish to work on and press the “Save and Continue” button on the corresponding EEM inventory/measure page (See FIG. 73). This will populate the results table and certain text fields in the report. This report can be customized and saved.

Press “Save Reports” to populate the final report with the measures proposed.

E. Pictures

The Pictures tab allows you to insert pictures taken during the audit into the file. These pictures will be populated within the audit report. The CEAT may be limited to 10 pictures per module, and 15 pictures overall in some embodiments and in other embodiments, there is not a limitation.

### Water Conservation Module

The water conservation module covers the retrofit of flush and flow fixtures. This module calculates the existing water usage, proposed water usage, and water savings, which are based on estimated water consumption by flush and flow fixtures.

An Input and Inventory EEM covers the retrofit of flush and flow fixtures with water efficiency fixtures. Flush fixtures include urinals and toilets (water closets). Their water consumption is measured in GPF (Gallons per Flush). Existing fixtures may be replaced with water efficient fixtures which include water less or low flow urinals, and dual flush or low flow water closets. Flow fixtures include faucets, aerators and shower heads. Their water consumption is measured in GPM (Gallons per Minute). Existing fixtures may be replaced with water efficient fixtures which include high pressure and low flow aerated fixtures.

One particular example of a Water Conservation Module may include:

A. Water Conservation Measures (WCMs) Covered

The water conservation module covers the retrofit of flush and flow fixtures. This module calculates the existing water usage, proposed water usage, and water savings, which are based on estimated water consumption by flush and flow fixtures.

Input and Inventory

This EEM covers the retrofit of flush and flow fixtures with water efficiency fixtures.

1) Flush fixtures include urinals and toilets (water closets). Their water consumption is measured in GPF (Gallons per Flush). Existing fixtures may be replaced with water efficient fixtures which include water less or low flow urinals, and dual flush or low flow water closets.

2) Flow fixtures include faucets, aerators and shower heads. Their water consumption is measured in GPM (Gallons per Minute). Existing fixtures may be replaced with water efficient fixtures which include high pressure and low flow aerated fixtures.

B. User Inputs

This module has user inputs only on input and inventory tab. The CEAT also uses inputs from the Utility Info to perform calculations, so it is imperative that these tabs are filled out as well.

Input and Inventory

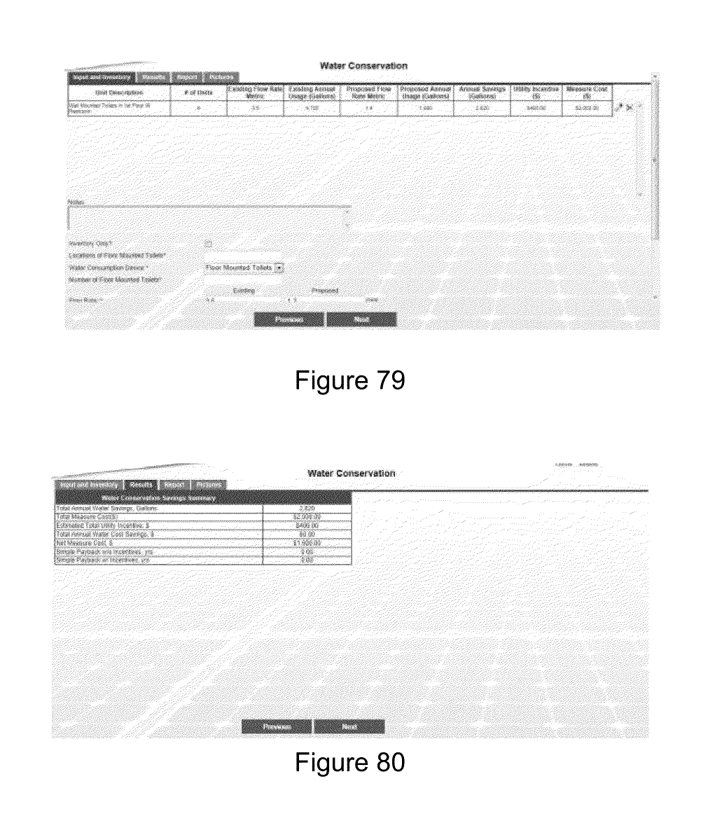

The inputs for this tab are used to calculate water savings from the retrofit of flush and flow fixtures (See FIGS. 78-79). The inputs are as follows:

1) Inventory Only: Check this box if you are not recommending any of the above measures, and the equipment only needs to be entered into the water fixture building's inventory.

2) Location of Water Consumption Device: Based on the user input of the water consumption device, the title of this input will be modified. Location could be a wing on a certain floor of the building in which this fixture is located.

3) Water Consumption Device

4) Number of Water Consumption Devices: Similar to location input, the title is modified based on the type of water consumption device.

5) Flow Rate: The CEAT automatically populates this information for both existing and proposed cases based on the type of water consumption device. However, this can be overridden by user inputs if needed. Flow rate is measured in GPF (Gallons per Flush) for flush fixtures and GPM (Gallons per Minute) for flow fixtures. These details can be found on the manufacturer specifications/cut sheets.

6) Usage Per Day: This value denotes the water usage of the water fixture in terms of minutes per day or flushes per day of the water fixture device or gallons per day of water usage by the existing water consumption device.

7) Occupied Days Per Year: Input the number of days in a year that the building is occupied.

8) Utility Incentive ($): Input the incentive provided by the applicable utility and select the unit of the incentive from the drop down list which includes $/Toilet, $/Urinals, $/Gallons, $/Faucet, $/Aerator, $/Showerhead.

9) Total Measure Cost: This is the estimated cost of a retrofitting or upgrading the selected water consumption device. The CEAT automatically populates this field, but this number can be changed if needed.

Once you are finished entering the user inputs on the Input and Inventory tab, press the “Save and Add” button followed by the “Save and Continue” button and the information entered for the unit will be added to the top of the tab (above the input fields) and you can begin entering information for a new unit.

When you are finished entering information for all units, press the “Save and Continue” button and you will be taken to the Results tab.

C. Results

The Results tab contains important calculated information for the water efficiency in flush and flow fixtures (See FIG. 80). If the measure tab has been left blank, then the results section will show zeros for all fields. The list of calculation information displayed on the results tab is as follows:

1) Total Annual Energy Savings

2) Total Measure Cost [$]

3) Estimated Total Utility Incentive [$]: This is the incentive for water savings or type of water fixtures proposed.

4) Total Annual Water Cost Savings [$]: This is the water (gallons) cost savings only.

5) Net Measure Cost [$]

6) Simple Payback w/o (without) Incentive [Years]

7) Simple Payback w/ (with) Incentive [Years]

D. Reports

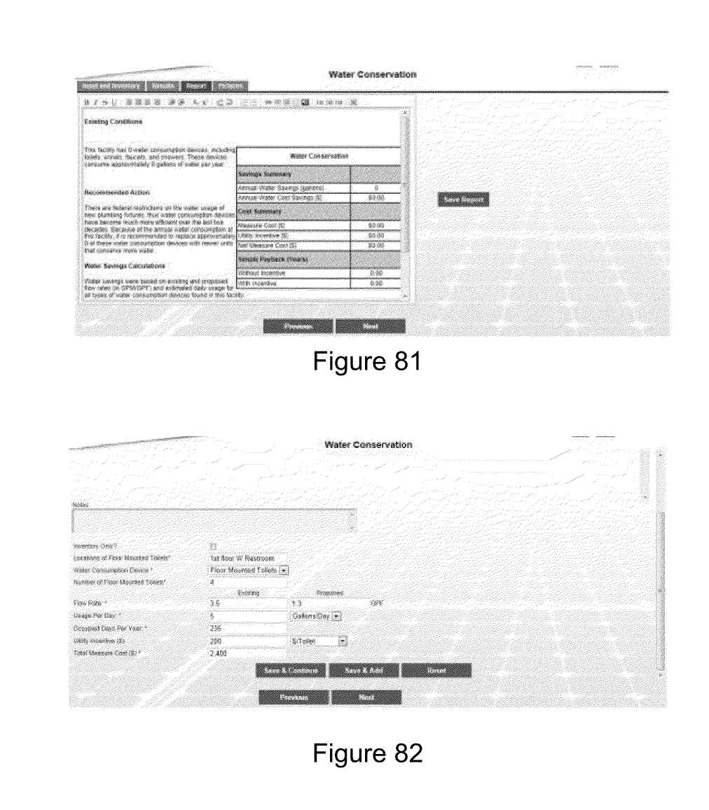

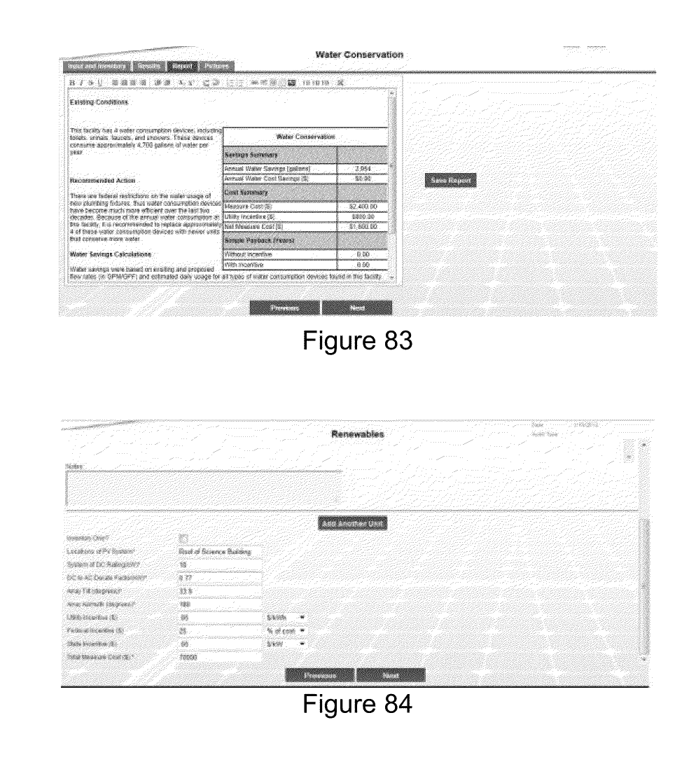

The Report tab generates reports for each Refrigeration measure and inserts the results information into a table in the report. The report for each section will be initially blank (See FIG. 81). To populate it, open the report you wish to work on and press the “Save and Continue” button on the corresponding EEM inventory/measure page (See FIG. 82). This will populate the results table and certain text fields in the report. This report can be customized and saved (See FIG. 83). Press “Save Reports” to populate the final report with the measures proposed.

E. Pictures

The Pictures tab allows you to insert pictures taken during the audit into the file. These pictures will be populated within the audit report. The CEAT is limited to 10 pictures per module, and 15 pictures overall

### Renewables Module

The renewables module covers the installation of new solar photovoltaic (PV) modules. This module calculates the annual energy savings [kWh] and peak demand savings [kW].

One particular example of a Renewables Module may include:

A. Renewable Measures (EEMs) Covered

The renewables module covers the installation of new solar photovoltaic (PV) modules. This module calculates the annual energy savings [kWh] and peak demand savings [kW].

B. User Inputs

This module has user inputs only on input and inventory tab. The CEAT also uses inputs from the Utility Info to perform calculations, so it is imperative that these tabs are filled out as well.

Input and Inventory

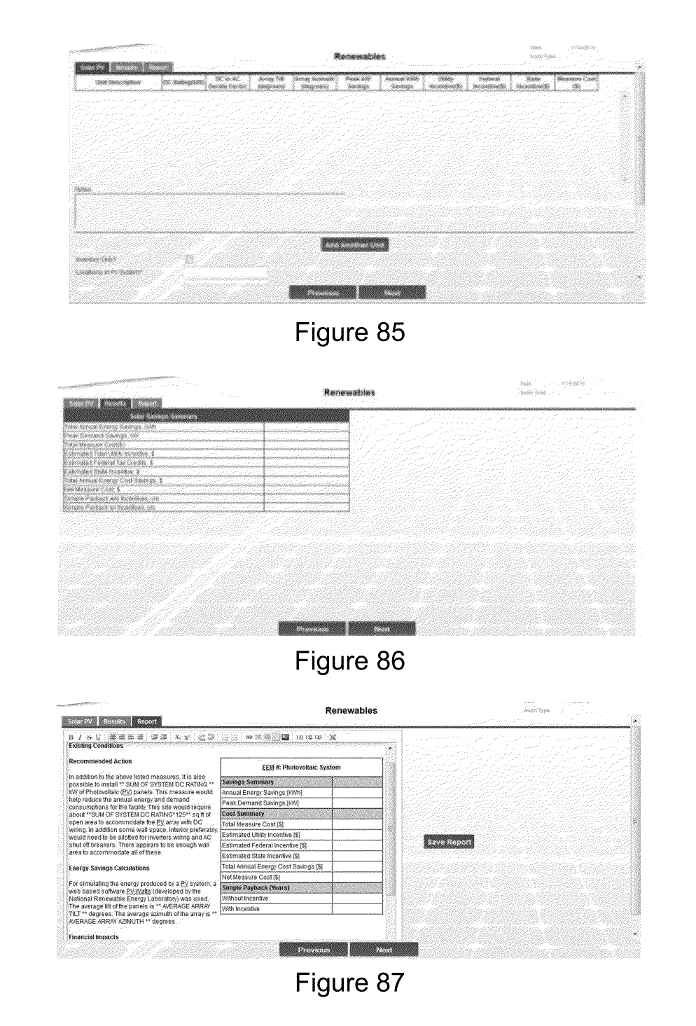

The inputs for this tab are used to calculate water savings from the retrofit of flush and flow fixtures (See FIGS. 84-85). The inputs are as follows:

1) Inventory Only: Check this box if you are not recommending any of the above measures, and the equipment only needs to be entered into the PV fixture building's inventory.

2) Location of PV System: Location is where the system is located.

3) System of DC Rating (kW): This is where the user inputs the total kW rating of the PV modules.

4) DC to AC Derate Factor (kW): This is the efficiency in which the DC current is switched to AC, usually through an inverter. Initially, CEAT automatically populates the box to be 0.77 if the user does not know the efficiency of the inverter. This number can also be manually input by the user if it is known.

5) Array Tilt (degrees): The array tilt is the angle at which the solar panels will be sloping with respect to the horizontal. This box is automatically populated by the CEAT tool to read 33.9. The user can change this value per their own specifications as desired.

6) Utility Incentive: This is the incentive value and type that is offered by the local utility for this measure. The units of the incentive can be adjusted to; $/kW, $/kWh, % of cost, and $.

7) Federal Incentive: This is the incentive offered by the government for this measure. The units of the incentive can be adjusted to; $/kW, $/kWh, % of cost, and $.

8) State Incentive: This is the incentive offered by the state government for this measure. The units of the incentive can be adjusted to; $/kW, $/kWh, % of cost, and $.

9) Total Measure Cost: This is the total cost of the project. Initially CEAT auto-populates the box to $7,000/System DC Rating (kW). The user can override this and input a custom measure cost also.

Once you are finished entering the user inputs on the Input and Inventory tab, press the “Save and Add” button followed by the “Save and Continue” button and the information entered for the unit will be added to the top of the tab (above the input fields) and you can begin entering information for a new unit.

When you are finished entering information for all units, press the “Save and Continue” button and you will be taken to the Results tab.

C. Results

The Results tab contains important calculated information for the water efficiency in flush and flow fixtures (See FIG. 86. If the measure tab has been left blank, then the results section will show zeros for all fields. The list of calculation information displayed on the results tab is as follows:

1) Total Annual Energy Savings

2) Total Measure Cost [$]

3) Estimated Total Utility Incentive [$]: This is the incentive for water savings or type of water fixtures proposed.

4) Total Annual Water Cost Savings [$]: This is the water (gallons) cost savings only.

5) Net Measure Cost [$]

6) Simple Payback w/o (without) Incentive [Years]

7) Simple Payback w/ (with) Incentive [Years]

D. Reports

The Report tab generates reports for each Refrigeration measure and inserts the results information into a table in the report. The report for each section will be initially blank. To populate it, open the report you wish to work on and press the “Save and Continue” button on the corresponding EEM inventory/measure page. This will populate the results table and certain text fields in the report (See FIG. 87). This report can be customized and saved. Press “Save Reports” to populate the final report with the measures proposed.

### Other Module

The Other Module includes different types of energy efficiency measures not covered in the modules already provided. The calculations take into account baseline energy usage and proposed energy usage of miscellaneous systems and equipment, as input by the user, which may include, without limitation the following systems and equipment.

1) A Plug Loads EEM that is the retrofit/upgrade of any large plug loads included in the building. This tab covers printers, copiers, refrigerators, and televisions.

2) A Miscellaneous Systems EEM is the retrofit/upgrade of miscellaneous loads included in the building, such as vending machines, cooking equipment, and motors.

3) An IT Systems EEM involves IT and computer systems in the building that have potential for energy savings, including PC power management, CRT to LCD computer monitors, server optimization, and plug load occupancy sensors.

4) A Pump Systems EEM is the retrofit/upgrade of pumping systems within the building by adding VFDs to areas where necessary.

Other systems and equipment may be included in the other module according to auditor needs and building components.

One example of the other module includes A. Energy Efficiency Measures (EEMs) Covered

The Other Module includes different types of energy efficiency measures not covered in the modules already provided. The calculations take into account baseline energy usage and proposed energy usage of miscellaneous systems and equipment, as input by the user.

Plug Loads

This EEM is the retrofit/upgrade of any large plug loads included in the building. This tab covers printers, copiers, refrigerators, and televisions.

Miscellaneous Systems

This EEM is the retrofit/upgrade of miscellaneous loads included in the building, such as vending machines, cooking equipment, and motors.

IT Systems

This EEM involves IT and computer systems in the building that have potential for energy savings, including PC power management, CRT to LCD computer monitors, server optimization, and plug load occupancy sensors.

Pump Systems

This EEM is the retrofit/upgrade of pumping systems within the building by adding VFDs to areas where necessary.

B. User Inputs

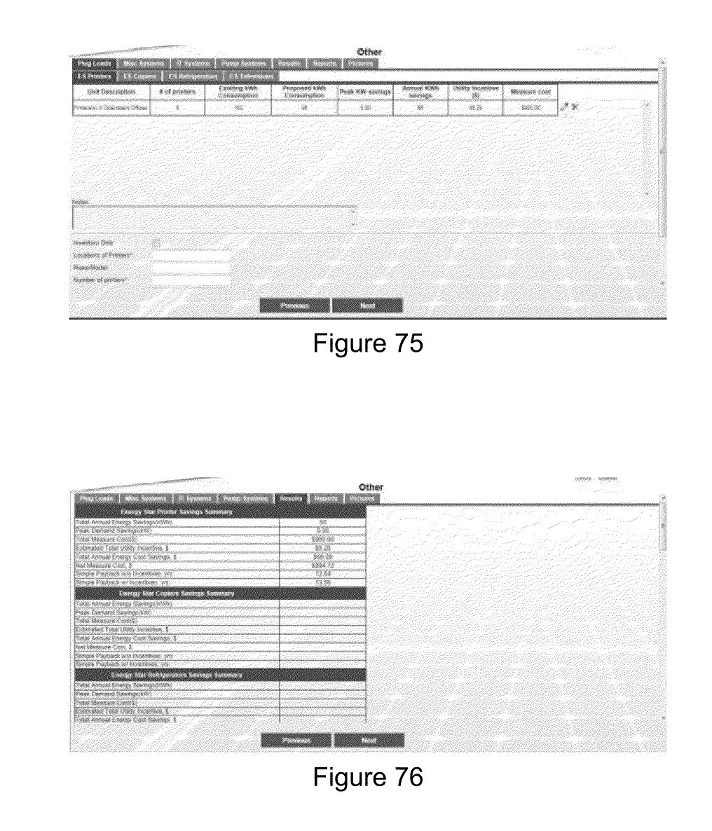

These are the inputs the user needs to give the CEAT so it can calculate savings and incentive numbers. User Inputs along with an inventory list of the equipment are found under each EEM tab (see FIGS. 74 and 75).

Plug Loads

The inputs listed below can be found on the ES Printers tab:

1) Inventory Only: Check this box if you are not interested in calculating energy savings for this piece of equipment and you only need the information for inventory purposes. When checked, all proposed fields will be disabled.

2) Location of Printers: This is a mandatory input to help identify which printers are being evaluated.

3) Make/Model

4) Number of Printers: Enter the number of existing printers for the units specified in the previous input.

5) Type of Printer: Select inkjet, laser monochrome, or laser color. If laser is selected, enter the speed of the printer from the drop-down menu.

6) Is Printer EnergyStar rated

7) Utility Incentive

8) Total Measure Cost

The inputs listed below can be found on the ES Copiers tab:

1) Inventory Only: Check this box if you are not interested in calculating energy savings for this piece of equipment and you only need the information for inventory purposes. When checked, all proposed fields will be disabled.

2) Location of Copiers: This is a mandatory input to help identify which copiers are being evaluated.

3) Make/Model

4) Number of Copiers: Enter the number of existing copiers for the units specified in the previous input.

5) Type of Copier

6) Is Copier EnergyStar rated

The inputs listed below can be found on the ES Refrigerators tab.

1) Inventory Only: Check this box if you are not interested in calculating energy savings for this piece of equipment and you only need the information for inventory purposes. When checked, all proposed fields will be disabled.

2) Location of Refrigerator(s): This is a mandatory input to help identify which refrigerators are being evaluated.

3) Make/Model.

4) Number of Refrigerators: Enter the number of existing refrigerators for the units specified in the previous input.

5) Size of Refrigerator

6) Is Refrigerator EnergyStar rated

7) Utility Incentive

8) Total Measure Cost

The inputs listed below can be found on the ES Televisions tab.

1) Inventory Only: Check this box if you are not interested in calculating energy savings for this piece of equipment and you only need the information for inventory purposes. When checked, all proposed fields will be disabled.

2) Location of Television(s): This is a mandatory input to help identify which televisions are being evaluated.

3) Make/Model

4) Number of Televisions: Enter the number of existing televisions for the unit specified in the previous input.

5) Screen Size (Diagonal)

6) Number of Hours per Day Television is ON

7) Number of Days per Year Television is ON

8) Utility Incentive

9) Total Measure Cost

Miscellaneous Systems

The inputs listed below can be found on the Vending Misers tab.

1) Inventory Only: Check this box if you are not interested in calculating energy savings for this piece of equipment and you only need the information for inventory purposes. When checked, all proposed fields will be disabled.

2) Location of Unit(s): This is a mandatory input to help identify which vending machines are being evaluated.

3) Type of Vending Machine: This is a mandatory input, select “snack” or “refrigerated” from the drop-down menu.

4) Number of Refrigerated Vending Machines

5) Wattage of Unit (kW)

The inputs listed below can be found on the Prem Eff Motors tab. (Prem Eff stands for Premium Efficiency).

1) Inventory Only: Check this box if you are not interested in calculating energy savings for this piece of equipment and you only need the information for inventory purposes. When checked, all proposed fields will be disabled.

2) Motor(s) Serve

3) Number of Motors

4) Motor HP

5) Motor Enclosure

6) Motor RPM

7) Existing Motor Efficiency: This value will populate based on the motor horsepower entered in a previous input. You can override this value if it appears to be inaccurate for your measure.

8) Proposed Motor Efficiency: This value will populate based on the motor horsepower entered in a previous input. You can override this value if it appears to be inaccurate for your measure.

9) Loading Percent of Motor

10) Does motor have VFD

11) Percent of Operating Hours: These inputs will only show up if “yes” is chosen on the previous entry. They are to establish the load profile of the motors. Enter the percentage of operating hours from when the motor is at 30% to when the motor is at 100%. The total of the percentages entered should equal 100%.

12) Existing Operating Schedule: These inputs help to describe the operating schedule of the motors being evaluated. There are three different options of days/schedules, and for each day you enter the times that the motors would turn on and the time that the motors would turn off. Also, enter the number of holidays, (where it is assumed that the motors will not be operating).

13) Utility Incentive

14) Total Measure Cost:

The inputs listed below can be found on the HE Cooking Equipment tab.

1) Inventory Only: Check this box if you are not interested in calculating energy savings for this piece of equipment and you only need the information for inventory purposes. When checked, all proposed fields will be disabled.

2) Unit Tag #

3) Make/Model

4) Unit Type

5) Number of Units

6) Average Prod Energy Cons. Rate (kW): Input is automatically populated based on the type of unit chosen, but the values can be changed if needed.

7) Operating Schedule: There are three different options of days/schedules, and for each day you enter the times that the motors would turn on and the time that the motors would turn off. Also, enter the number of holidays, (where it is assumed that the equipment will not be operating).

8) Utility Incentive

9) Total Measure Cost

IT Systems

The inputs listed below can be found on the PC Power Management tab.

1) Inventory Only: Check this box if you are not interested in calculating energy savings for this piece of equipment and you only need the information for inventory purposes. When checked, all proposed fields will be disabled.

2) Location of Computer(s)

3) Type of Monitor

4) Number of Computers with LCD/CRT Monitors

5) Hours of Operation

6) Utility Incentive

7) Total Measure Cost

The inputs listed below can be found on the PC Power Mgmt tab.

1) Location of Monitors: This input is to help identify which pieces of equipment are being evaluated for this measure.

2) Make/Model

3) Number of Units

4) Number of Hours per Day Monitor is ON

5) Number of Days per Year Monitor is ON

6) Utility Incentive

7) Total Measure Cost

The inputs listed below can be found on the Server Optimization tab.

1) Inventory Only: Check this box if you are not interested in calculating energy savings for this piece of equipment and you only need the information for inventory purposes. When checked, all proposed fields will be disabled.

2) Locations of Servers

3) Make/Model/Tag

4) Server Type

5) Number of Units

6) Wattage per Server Unit

7) Server Utilization: Enter the average IT loading for the servers. There is an input for both “Existing” and “Proposed” situations. The Existing Server Utilization can be determined by running a server report.

8) Hours of Server Operation: This field is automatically populated assuming that the servers run 24/7. This value can be overridden if necessary.

9) Number of UPS: Enter the number of UPSs involved in this measure.

10) HVAC COP: Enter the Coefficient of Performance (COP) for the HVAC system providing cooling to the servers/server room.

11) Utility Incentive

12) Total Measure Cost

The inputs listed below can be found on the PLOS tab.

1) Inventory Only: Check this box if you are not interested in calculating energy savings for this piece of equipment and you only need the information for inventory purposes. When checked, all proposed fields will be disabled.

2) Number of PLOS

3) Location of PLOS

4) Plug Loads Conn (max. four devices only): Provide the number of plug loads involved in this evaluation.

5) Estimated Total Wattage Controlled (W): Provide an estimate of how much energy is saved using PLOSs.

6) Utility Incentive

7) Total Measure Cost

Pump Systems

The inputs listed below can be found on the VFD on Pumps tab.

1) Inventory Only: Check this box if you are not interested in calculating energy savings for this piece of equipment and you only need the information for inventory purposes. When checked, all proposed fields will be disabled.

2) Area Pumps Serve

3) Number of Motors

4) Motor HP

5) Efficiency of Motors

6) Does Motor have VFD

7) Percent of Operating Hours: These inputs are to establish the load profile of the motors. Enter the percentage of operating hours from when the motor is at 30% to when the motor is at 100%. The total of the percentages entered should equal 100%.

8) Operating Schedule: These inputs help to describe the operating schedule of the motors being evaluated. There are three different options of days/schedules, and for each day you enter the times that the motors would turn on and the time that the motors would turn off. Also enter the number of holidays, (where it is assumed that the motors will not be operating).

9) Utility Incentive

10) Total Measure Cost

C. Results

The Other Module Results tab contains the calculated incentives for each proposed EEM (plug loads, miscellaneous systems, IT systems, and pump systems). These fields will automatically calculate and populate once the Other Inventory tab is completed (see FIG. 76).

D. Reports

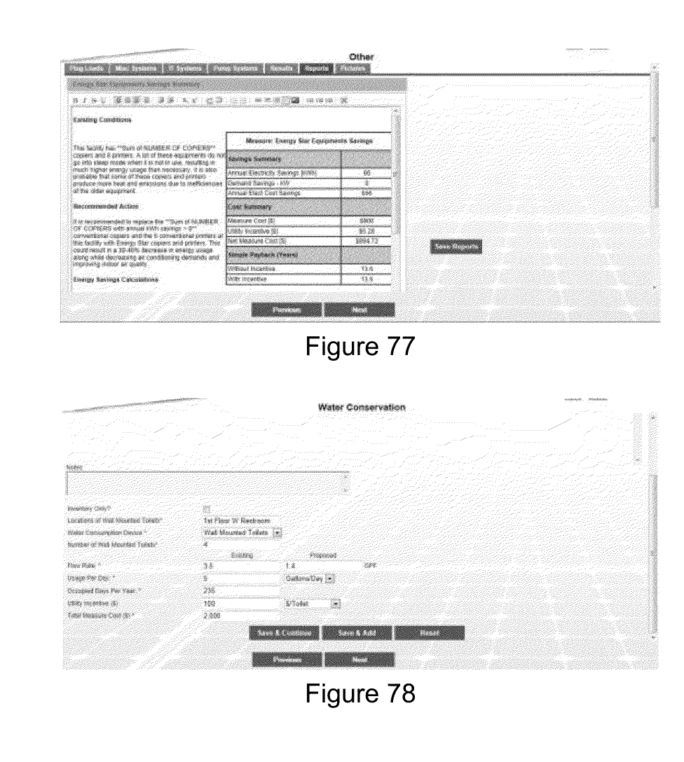

The Reports tab generates a report outline and inserts the results information into a table (see FIG. 77). This report can be manipulated and saved.

E. Pictures

The Pictures tab allows you to insert pictures taken during the audit into the file. These pictures can be used for audit reports later

### Additional Considerations

All of the modules related to prescriptive measures may include particular features. For example, in embodiments, with the exception of the lighting module, all prescriptive measures may be strictly evaluated as prescriptive and cannot go through the customized incentive program. With the lighting module specifically, users may have the option to choose if the measure will go through the custom/prescriptive category. Further, calculations of savings will be based on the prescriptive approach via a look-up table containing the savings (kWh, kW), cost and incentive values from a master database. Lookup tables and databases are stored on the server and accessible from the server by the onsite tool operating on the communication device.

The audit tool calculates the customer's reportable deemed energy savings for prescriptive measures. The audit tool also operates to map the prescriptive measures with corresponding $/metric incentives, kW/metric, kWh/metric. Additionally, the audit tool disables incentive value and type based on user selection of proposed light type in order to avoid humane error.

Other features of prescriptive measures modules may include gas penalty values for lighting retrofits within the lighting module. The audit tool may include the production of a pie chart for dollar values of energy consumption for various end uses within the final report. The dollar values in the pie chart will be based on the average electric rates ($/kWh) and be displayed below the existing pie chart with different % end uses. The audit tool may also generate a customer application. The audit tool may also include accounting for kW capacity for solar PV installation based on a % of the proposed peak kW calculated for the building from the recommended Energy Efficiency Measures (“EEM”).

Embodiments of the audit tool perform audit functions related to demand response (hereinafter “DR”) measures. The audit tool includes standardized energy engineering calculations with supporting references. Also, the audit tool performs DR measures on both the existing as well as proposed Energy Efficiency (“EE”) recommendations thereby evaluating the DR savings either separately or integrated with the EE recommendations. Accordingly, if a customer wishes to take advantage of DR incentives, the audit tool can provide that particular type of information to help identify the savings by participating in reducing demand at a particular time of day. The audit tool has the capability to generate fully editable DR reports as well as Integrated EE+DR report in a common word processing format. The audit tool also covers all DR Measures for commercial buildings less than or equal to 120,000 square feet.

Embodiments of the audit tool perform audit functions related to renewable measures. Features regarding renewable measures include calculating savings due to Solar Photovoltaic (PV) System installations. Additionally, engineering calculations for the PV installation are calculated consistent with stored data. The audit tool also provides the ability to enter and calculate utility, federal and state incentives in the form of $/kW, $/kWh, % of cost, and as a fixed $ amount. Embodiments of the renewable measures of the audit tool may also include collecting and analyzing additional solar (like solar thermal, etc) and other renewable measures.

Embodiments of the audit tool include an Inventory Only Collection Feature. This feature provides a simplified user interface that assists in taking inventory of all energy-consuming items within a commercial facility. This user interface may be on the communication device operating as part of the onsite tool. The audit tool when using the “Inventory Only” feature at the site offers the flexibility for the engineering staff to not only save on audit time, but also on resource allocation as junior staff/technicians could be utilized for performing the streamlined audits. Additionally, users can access the audit tool at a later time and select an audit type for a more thorough engineering analysis with the tool on EE, DR, or integrated EE+DR.

Embodiments of the audit tool comprise a Free Flow and Central Plant Module. The Free Flow and Central Plant Module provides for using the Inventory Only feature for free flow energy-efficiency measures and central plant data. The tool allows for the collection of the information electronically while on site and then allows the user to return to the office to perform the detailed calculations. The communication device operating the onsite tool operates to send the collected information through a communication network to the server. The user may then access the server from a separate computer or computing device in order to perform the detailed calculations required to finalize the audit.

The Free flow and Central Plant Module accounts for the measures not included in another feature or module within the audit tool. This module also allows users to enter kW, kWh and therm savings in text boxes within the free-flow and Central Plant module for storing within the database. The savings estimates will be entered by the user after they have performed the calculations needed to consolidate manual calculation savings and the savings estimates from a database.

The audit tool also includes all data within the Central plant and free flow modules into a spreadsheet output report that could be downloaded. Additionally, a spreadsheet calculation file upload for the free flow and central plant inventory measures, individual reports, and the like, may be included. The use of a communication device that is mobile increase ease of use or mobile functionality of free flow and central plant Inventory Only feature.

The audit tool comprises a Utility Energy Bill Data and Incentives feature. Embodiments of this feature include accounting for usage of average electric cost ($/kWh) to calculate annual energy costs is consistent with ASHRAE Level 1 & 2 audit analysis. Further, utility incentives may be calculated for each IDSM measure by the audit tool based on a prescriptive/custom approach depending on utility programs. Also, utility incentives for all custom EEMs within the software may be capped at a predetermined percentage, such as 50%, measure cost limitation consistent with typical regulations. Further still, utility incentives for prescriptive EEMs are not capped and will simply be based on cumulative incentives based on metrics ($/lamp, $/ton, etc.) consistent with standardized policies.

Some embodiments of the audit tool provides the ability for entry of information for each type of commodity (e.g., Electricity, Gas, and Water) to be inputted within the Utility Information page. This page may be accessible through the communication device. Users will be able to enter utility information for a predetermined time frame, such as up to 36 months. Average cost metrics ($/kWh, $/therm, etc.), savings calculations and estimates % will be based on this predetermined time frame of entered utility information. The audit tool may have the option of importing standard spreadsheet file templates containing the energy/gas and water history into each of these tables on the web. A copy of the standard excel file template for energy/gas and water history is attached in the Appendix.

Further, the audit tool may provide an enhanced final report to display the cumulative energy and peak demand consumption values across the first 12 months of all meter accounts entered by the user. Similar approaches may also be used for populating the bar chart within the Appendix of the final report. In this embodiment users will have to enter energy history for the same exact time periods for all the meters into the audit tool.

Further still, according to embodiments of the audit tool, specific utility rate types (TOU, expandable block rate, etc.) can be programmed into the tool to calculate the annual energy cost savings. The audit tool may also be programmed with default incentive values (prescriptive/custom) for each IDSM measure based on the utility requirements. Future adjustments to the incentive amount cap (if any) for the EEMs can also be done based on standardized requirements.

The audit tool provides an Energy Audit Report. The Energy Audit Report includes various features. Each IDSM module contained in the software includes an editable IDSM report that the user can customize. All audit customizations appear within the final standard report that contain 1. Basic building information with facility electric usage, EUI, pie chart showing existing site energy end uses; 2. IDSM recommended measures to customers along with their individual & total project ROIs (simple payback only), wherein existing conditions, recommended action, and energy savings calculation methodology along with the financial impact tables for each EEM, and wherein the tables with the savings and payback numbers are also presented as an editable format; and 3. Appendices with kWh consumption graph on a monthly basis and site pictures with captions. Further, embodiments provide for making changes (such as logo on the cover letter, EEM contents, formatting, and tables) or customizations to the standard report.

The audit tool accounts and operable for certain Weather Zones and Building Types. For example and without limitation, weather zone files for locations are in built within the software. The audit tool also includes use with certain building types. According to some embodiments, these buildings include:

1. Assembly

2. Education—Primary

3. Education—Secondary

4. Education—Community Colleges

5. Education—Universities

6. Grocery

7. Health/Medical (hospital, clinic),

8. Lodging—Hotels

9. Lodging—Motels

10. Lodging—Guest Rooms

11. Manufacturing (light industrial),

12. Office—Small

13. Office—Large

14. Restaurant—Sit Down

15. Restaurant—Fast Food

16. Retail—3 Story

17. Retail—Single Story

18. Retail—Small

19. Storage—Conditioned

20. Storage—Unconditioned

21. Warehouse—Refrigerated

22. Misc. Commercial

The audit tool can evaluate HVAC measures for the building types that include, but are not limited to, the following:

1. School—Primary

2. School—Secondary

3. Lodging—Hotel

4. Lodging—Motel

5. Office—Large

6. Office—Small

7. Restaurant—Sit Down

8. Restaurant—Fast Food

9. Retail—3-Story Large

10. Retail—Single-Story Large

11. Retail—Small, Warehouse

The audit tool can evaluate certain building types regarding water heating. These buildings include, but are not limited to:

1. School—Primary

2. School—Secondary

3. Lodging—Hotel

4. Lodging—Motel

5. Office—Large

6. Office—Small

7. Restaurant—Sit Down

8. Restaurant—Fast Food

9. Retail—3-Story Large

10. Retail—Single-Story Large

11. Retail—Small, Warehouse

The audit tool can handle refrigeration EEMs for at least the Restaurant segment. The audit tool may also handle Central Plant and Free Flow for inventory only.

The audit tool may perform accounting of EEMs that are not weather and building type dependent and thus, may be applicable for all building types.

Water Conservation measures currently within the audit tool are not building type dependent and thus, may be applicable for all building types.

The audit tool may include administrative access with the capability to 1. Approve and deny individual user access; 2. Restrict user access to specific modules of the audit tool; 3. Overview all building information & data entered into the tool by any approved individual auditor; and 4. Data sorting capability based on preselected parameters as included in the off-the-shelf version of the software. The parameters for data sorting are Project Creation Dates, Audit Contractor/Company, Auditor Name, Project ID, Location—City, State and Zip Code, Customer Name, Building Type, Gross Floor Area of facility, and HVAC parameters—viz., existing unit type, cooling tons, age, efficiency.

In some embodiments, based on customer selection of the parameters for data sorting, the Admin user of the audit tool will be able to output the data into a spreadsheet file. The spreadsheet file may contain building information input by the user and the various EEMs and DR savings estimates from the tool categorized on an end-use basis (e.g., Lighting, HVAC, Water Heating, etc.).

### Operation of Energy Audit Tool

In operation, a single auditor that has been selected to perform an energy audit would travel onsite to a building to be audited. The auditor uses a communication device to access an onsite secure web-based application tool, wherein the onsite tool includes a user interface wherein the auditor can access several modules of the onsite tool. Accordingly, in order to access the onsite tool, the communication device must have a network connection. The onsite tool access the web server of the audit tool and thereby has access to certain data already stored in a database of the web server. The onsite tool may be utilized to select a building type. Once a building type is selected, the onsite tool automatically populates field of the various module based on information stored in the database of the web server. The auditor may then enter information through the onsite tool operating on the communication device for the entire building and systems in the building, thereby eliminating the need for multiple auditors to perform audits on the different systems of the building. In other words, an audit may be conducted by a single auditor using the energy audit tool. Further, in some embodiments, the onsite tool is an app for a mobile computing device that accesses the server through a network connection.

The communication device comprises a cache, wherein the onsite tool may store data locally on the communication device cache. In particular, the communication device provides the network connectivity. If the communication device loses connectivity to the network the onsite tool automatically stores input from the auditor in the cache of the communication device. Once connectivity of the communication device is reestablished, the data stored in the cache is then transmitted to the web server. The auditor will have a predetermined amount of time in order to establish connectivity of the communication device without losing the data. For example, the auditor may have 24 hours, or may have 12 hours or may even have 6 hours to establish connectivity.

When connectivity is established, data entered by the auditor through the onsite tool is automatically saved on the server. As the auditor enters information and the data is saved on the server, the onsite tool automatically performs any necessary calculations and can be seen in real time.

Additionally, the onsite tool allows for an auditor to upload pictures taken during the audit. For example, an auditor may wish to take a picture of a lighting fixture as a reference for the type of lighting fixture and general condition of the lighting fixture in the building. The auditor may take this picture using the communication device. The onsite tool may then access the stored picture in the communication device and upload it to the server. The audit tool will then incorporate the picture into reports generated by the audit tool.

Once all data is input using the onsite tool, the audit tool may then produce results and reports. Generally, these reports produce a standard report that provides a breakdown of the energy consumption for different systems in a building that utilize energy. It also provides for recommended actions. Additionally, while these reports are automatically generated by the audit tool, embodiments allow the reports to be generated in a word processing format, wherein the auditor may customize the report according to customer needs or requirements.

This audit tool also stores all of this information and allows for a company to access all the information at a later date. Further, the stored data is searchable through the audit tool. All of the data that is accessible on the audit tool may be parsed and searched by that specific data type. For example, and without limitation, the data may be searched for building type, auditor, equipment type, geographic location, main company, utility program and the like. This allows for comparisons among buildings, for quality control of auditors and the like.

In some embodiments, the audit tool may include a customer actionable item feature. The customer actionable item feature may comprise the automatic generation of an email by the audit tool to a customer with specific detailed actions to take with regard to a particular piece of equipment in order to save energy costs. For example, data is uploaded into the audit tool by use of the onsite tool. After performing calculations and other tests on a specific piece of equipment, such as a water heater, the costs of running the water heater may be calculated and further the efficiency of the water heater may be calculated and then compared to the standard efficiency for that particular type of water heater. If the customer's water heater is operating at a lower efficiency, the email would be sent to the customer indicating the issue and suggesting corrective action to undergo.

A method of using an energy audit tool comprises the steps of accessing an onsite secure web-based application tool using a communication device from an onsite location; entering data in a plurality of modules of the onsite secure web-based application tool; automatically storing input data in cache of the communication device if network connectivity is lost; automatically uploading data from cache to a server when connectivity is established; and generating reports based on the information submitted through the onsite secure web-based application tool. It will be understood that other various method steps may be incorporated as discussed in the operation of the energy audit tool.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. An energy audit tool comprising:
a server;
a communication device in communication with the server; and
an onsite secure web-based application tool operable on the communication device, wherein the onsite secure web-based application tool comprises a plurality of modules for performing audit functions, wherein the energy audit tool performs all energy efficiency measures applicable to a building type being audited.

2. The tool of claim 1, wherein the communication device is a computing device.

3. The tool of claim 1, wherein communication device is a mobile computing device.

4. The tool of claim 1, wherein the server stores information input during the audit, wherein the audit tool tracks this information by building type, auditor, equipment type, geographic location, main company, utility program and the like.

5. The tool of claim 1, wherein the plurality of modules comprises a lighting module, an HVAC module, a Water Heating module, a Refrigeration module, a Water Conservation module, a Renewables module, a PC Power Management module, a Variable Frequency Drives (“VFD”) on Evaporative Fans and Pumps module, a VFD on Kitchen Exhaust Fans module, a Plug Load Occupancy Sensor module, an Auto Door Closer module, an High Efficiency Cooking Equipment module, an High Efficiency Ice Maker module, and a Vending Misers module.

6. An energy audit tool comprising:
a server;
a communication device in communication with the server; and
an onsite secure web-based application tool operable on the communication device, wherein the onsite secure web-based application tool comprises a module for performing audit functions, wherein the energy audit tool performs all energy efficiency measures applicable to a building type being audited and automatically saves audit data to the server, and wherein:
the of module comprises one of a lighting module, an HVAC module, a Water Heating module, a Refrigeration module, a Water Conservation module, a Renewables module, a PC Power Management module, a Variable Frequency Drives (“VFD”) on Evaporative Fans and Pumps module, a VFD on Kitchen Exhaust Fans module, a Plug Load Occupancy Sensor module, an Auto Door Closer module, an High Efficiency Cooking Equipment module, an High Efficiency Ice Maker module, or a Vending Misers module.

7. The tool of claim 6, wherein the communication device is a computing device.

8. The tool of claim 6, wherein communication device is a mobile computing device.

9. The tool of claim 6, wherein the server stores information input during the audit, wherein the audit tool tracks this information by building type, auditor, equipment type, geographic location, main company, utility program and the like.

10. The tool of claim 6, where in the web-based application tool performs audit functions related to prescriptive measure.

11. The tool of claim 6, wherein the communication device comprises a cache, wherein the onsite tool stores data locally on the communication device cache.

12. The tool of claim 11, wherein the communication device automatically stores input from an auditor in the device cache in response to loss of communication with the server.

13. The tool of claim 12, wherein the communication device automatically transmits stored data to the server in response to reestablishing communication with the server.

14. The tool of claim 6, wherein the web-based application tool produces results and reports in response to audit data received.

15. The tool of claim 6, wherein the web-based application tool provides recommended actions based on the audit data.

16. The tool of claim 6, further comprising a customer actionable item feature, wherein the feature automatically generates a communication to a customer with specific detailed actions to take based on the audit data.

17. An method of using energy audit tool, the method comprising:
accessing an onsite secure web-based application tool using a communication device from an onsite location;
entering data in a plurality of modules of the onsite secure web-based application tool;
automatically storing input data in cache of the communication device if network connectivity is lost;
automatically uploading data from cache to a server when connectivity is established; and
generating reports based on the information submitted through the onsite secure web-based application tool.

18. The method of claim 17, wherein entering data in the plurality of modules comprises entering data in more than one of a lighting module, an HVAC module, a Water Heating module, a Refrigeration module, a Water Conservation module, a Renewables module, a PC Power Management module, a Variable Frequency Drives (“VFD”) on Evaporative Fans and Pumps module, a VFD on Kitchen Exhaust Fans module, a Plug Load Occupancy Sensor module, an Auto Door Closer module, an High Efficiency Cooking Equipment module, an High Efficiency Ice Maker module, or a Vending Misers module.

19. The method of claim 17, further comprising automatically generating a communication to a customer with specific detailed actions to take based on the audit data.

20. The method of claim 17, further comprising conducting the audit by a single auditor.
